(19) United States
(12) Patent Application Publication
(10) Pub. No.: US 2026/0101892 A1
(43) Pub. Date: Apr. 16, 2026

(54) METHOD TO INHIBIT PROLIFERATION OF A PHYTOPATHOGEN ON PLANTS AND COMPOSITIONS USED FOR THIS PURPOSE

(71) Applicant: CYSBIO APS, Hørsholm (DK)

(72) Inventors: Alex Toftgaard NIELSEN, Hørsholm (DK); Henrik MEYER, Hørsholm (DK); Christian Bille JENDRESEN, Hørsholm (DK); Sebastian Sven BRØNDUM, Hørsholm (DK)

(21) Appl. No.: 19/115,872

(22) PCT Filed: Oct. 3, 2023
(86) PCT No.: PCT/EP2023/077338

§ 371 Date: Mar. 27, 2025

(30) Foreign Application Priority Data
Oct. 4, 2022 (DK) PA202270484

(51) Int. Cl. A01N 37/02; A01P 3/00

(52) U.S. Cl. CPC A01N 37/02; A01P 3/00

(57) ABSTRACT

The present invention generally relates to the agricultural industry, and specifically to the protection of crops, seeds and fruits against fungal and/or oomycetes pests. The present invention provides the use of hydroxycinnamic acid or a derivative thereof for protection of crops, seeds or fruits against at least one fungal and/or oomycetes pest, wherein a composition comprising hydroxycinnamic acid or a derivative thereof is applied to the surface of said crops, seeds or fruits by spraying or by immersion into said composition

### TECHNICAL FIELD

The present invention relates to the agricultural industry, and specifically to the inhibition of proliferation of phytopathogens affecting plants and products derived therefrom, such as crops, seeds and fruits using an antifungal composition.

### BACKGROUND

In agriculture there is a need for pesticides to control pests. One class of pesticides are fungicides which control fungal and/or oomycetes pests that thrive on plants such as crops, seeds and fruits thus diminishing or eliminating the yields. Typically, conventional pesticides that directly kill or inactivate the pest, are used to protect crops and seeds from fungal and/or oomycetes pests. One example of this is the use of copper based contact fungicides which are heavily used for several different applications. However, due to their toxicity and for environmental reasons conventional synthetic pesticides may not be the preferred option to prevent fungal and/or oomycetes pests in agriculture.

Biopesticides is a growing and sought after area for both conventional and organic farming. Biopesticides are classified into three different categories: biochemical pesticides, microbial pesticides and plant-incorporated-protectants. The majority of current biopesticides are microbial pesticides which have a microorganism as the active ingredient. Microbial pesticides generally are quite specific in target organisms and also have a range of handling, application and efficacy limitations. In contrast, biochemical pesticides are non-living, naturally occurring substances that control pests by non-toxic mechanisms and thus do not have the same limitations. Unfortunately, the selection of biochemical pesticides currently available to protect against fungal infections is highly limited.

Zosteric acid has previously in WO 2000/16624 been investigated as a biofilm inhibiting compound and has since in Stanley et al. 2002 (Phytopathology, May 2002) been studied in artificial rice blast systems for inhibition of fungal spore adhesion. However, these findings have not been translated into practical application in crop protection under realistic conditions for inhibition of proliferation of fungal pathogens, and the prior art further remains silent with respect to effective inhibition of proliferation of oomycetes on plants or plant products.

There is therefore a great need for new effective biochemical pesticides with effect on fungal diseases in a realistic setting, and which exhibit a broad efficacy spectrum, and which can be applied as normal contact fungicides like e.g. the copper based contact fungicides. Further, there is a need for agents capable of inhibiting proliferation of oomycetes and diseases resulting from this class of pathogens.

### SUMMARY

The object of the present invention is to provide means allowing an efficient and more environmentally friendly protection of plants and products deriving therefrom, such as crops, seeds and fruits against phytopathogens, such as fungi and oomycetes. Oomycetes are a class of filamentous, eukaryotic microorganisms that include some of the most devastating plant and animal pathogens. It is an object of the present disclosure to effectively inhibit the proliferation of oomycetes.

More particularly, it is an object of the present invention to provide means allowing the crops, seeds and fruits to be grown, harvested, transported, stored and used with reduced degradation by phytopathogens. Further it is an object of the present invention to reduce or inhibit lesion from fungal and/or oomycetes pests on crops and fruits. It is furthermore an object of the invention to inhibit the adhesion and growth of fungal spores and cells to the surface of crops, seeds and fruits.

This is achieved by the finding that hydroxycinnamic acid or a derivative thereof enhances the resistance of crops, seeds and fruits against fungal infection and the ensuing consequences, notably reduced sprouting, reduced growth and crops yield, and reduced shelf life of crops, fruits and vegetables. Hydroxycinnamic acid and derivatives thereof such as sulfated derivatives have been studied for many years for their antioxidant and other beneficial properties, see e.g. Teixeira et al, BioMed Research International (2013) Article ID 251754. Broader commercial applications have often been limited by e.g. high cost of production.

The present disclosure provides in one aspect, a method for inhibiting proliferation of a phytopathogen on a plant or a product derived therefrom, comprising contacting the phytopathogen with a composition comprising a hydroxycinnamic acid or a derivative thereof thereby inhibiting proliferation of the phytopathogen.

In a further aspect, the present disclosure provides a method for protection of a plant or a product derived therefrom against at least one phytopathogen, comprising applying a composition comprising a hydroxycinnamic acid or a derivative thereof to the surface of said plant or a product derived therefrom.

In a further aspect, the present disclosure provides a composition comprising a hydroxycinnamic acid or derivative thereof according to the formula:

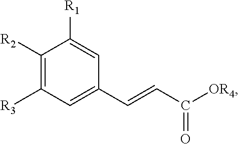

wherein R₁, R₂ and R₃ independently are selected from the group consisting of hydrogen (H), hydroxyl (OH), C₁₋₆-alkyl and C₁₋₆-alkoxy, —O—SO₂—OR₅, wherein R₅ is selected from the group consisting of: hydrogen and C₁₋₆-alkyl;
provided that at least one of R₁, R₂ and R₃ is hydroxyl (OH) or —O—SO₂—OR₅, and R₄ is selected from the group consisting of hydrogen (H) and C₁₋₆-alkyl.

In one aspect, the present disclosure provides a crop comprising the composition as defined herein. In one aspect, the present disclosure provides a fruit comprising the composition as defined herein. In one aspect, the present disclosure provides a seed comprising the composition as defined herein.

The present invention thus provides in one aspect the use of hydroxycinnamic acid or a derivative thereof for protection of crops, seeds or fruits against at least one fungal and/or oomycetes pest, wherein a composition comprising hydroxycinnamic acid or a derivative thereof is applied to the surface of said crops, seeds, fruits or vegetables by spraying or by immersion into said composition.

More particularly, the present invention provides protection against fungal diseases by applying hydroxycinnamic acid or a derivative thereof to e.g. leaves of row crops. It has surprisingly been found that effective prevention of downy mildew (plasmopara viticola) in wine crops can be achieved, where the treatment demonstrates a similar or better level of disease prevention as commonly used fungicide standards-exemplified by comparison to copper-based contact fungicides. Also, surprisingly disease prevention in potatoes is achieved by reducing infection of potato blight (Phytophthora infestans) and for small grain cereal crops by reducing yellow rust (Puccinia striiformis f.sp. tritici) on wheat.

The present invention provides in one aspect effect against a broad range of seed borne diseases in crops, when applied on seeds or seedlings before sowing or planting, thereby preventing disease development on seedling, leaves, grain, fruit or vegetables. Exemplified by disease reduction in barley of barley stripe disease (Puccinia striiformis) and wheat bunt (Tilletia Caries) in wheat.

The present invention provides in a further aspect effect on pre-harvest or post-harvest treatment on fruit preservation preventing fungal disease impact on fruit and fruit crops before or after harvest. This is surprisingly observed by zosteric acid's ability to, post-harvest, delay fungal infection of capsicums and lemons with A. alternata and P. digitatum, respectively.

The present invention provides in a further aspect a biofungicide composition comprising hydroxycinnamic acid or a derivative thereof in a concentration from about 0.1% w/w to about 10% w/w, water and a preservative.

### DESCRIPTION OF DRAWINGS AND FIGURES

The figures included herein are illustrative and simplified for clarity, and they merely show details which are essential to the understanding of the invention, while other details may have been left out. Throughout the specification, claims and drawings the same reference numerals are used for identical or corresponding parts. In the figures and drawing include herein:

FIG. 1 shows in FIGS. 1A, B, C, and D the effect (efficacy and phytotoxicity) of zosteric acid on downy mildew in wine.

FIG. 2 shows using zosteric acid as a contact fungicide to prevent yellow rust in wheat.

FIG. 3 shows in FIGS. 3A and B application of zosteric acid as a seed dressing fungicide for prevention of common bunt of wheat and Barley stripe.

FIG. 4 shows application of zosteric and coumaric acid for post-harvest food preservation.

FIG. 5 shows the results from the downy mildew trial. The results clearly show that coumaric- and zosteric-acid have similar efficacy at all concentrations tested, suggesting sulfation of the hydroxycinnamic acid does not affect its ability to control disease.

FIG. 6 shows the efficacy of zosteric acid for controlling powdery mildew (Podosphaera aphanis) in strawberries (Fragaria sp.). The efficacy was evaluated as % area of leaves that were infected with disease based on evaluation of 50 leaves from each plant. The evaluation was performed 30 days after the first treatment and 10 days after the last treatment.

### INCORPORATION BY REFERENCE

All publications, patents, and patent applications referred to herein are incorporated by reference to the same extent as if each individual publication, patent, or patent application was specifically and individually indicated to be incorporated by reference. In the event of a conflict between a term herein and a term in an incorporated reference, the term herein prevails and controls.

### DETAILED DESCRIPTION

The features and advantages of the present invention are readily apparent to a person skilled in the art by the below detailed description of embodiments and examples of the invention with reference to the figures and drawings included herein.

Unless specifically defined herein, all technical and scientific terms used have the same meaning as commonly understood by a skilled artisan in the fields of agriculture, pesticides, biopesticides, biology and microbiology.

All methods and materials similar or equivalent to those described herein can be used in the practice or testing of the present invention, with suitable methods and materials being described herein. All publications, patent applications, patents, and other references mentioned herein are incorporated by reference in their entirety. In case of conflict, the present specification, including definitions, will prevail. Further, the materials, methods, and examples are illustrative only and are not intended to be limiting, unless otherwise specified.

The practice of the present invention will employ, unless otherwise indicated, conventional techniques of agriculture, crop growth and maintenance, seed dressing and fruit growth and surface treatment and coating, which are within the skill of the art. Such techniques are explained fully in the literature.

In a first aspect the present invention provides the use of hydroxycinnamic acid or a derivative thereof for protection of crops, seeds or fruits against at least one fungal and/or oomycetes pest, wherein a composition comprising hydroxycinnamic acid or a derivative thereof is applied to the surface of said crops, seeds or fruits by spraying or by immersion into said composition.
In an embodiment the hydroxycinnamic acid or a derivative thereof is

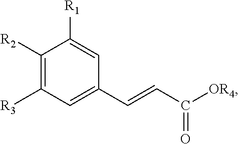

wherein R₁, R₂ and R₃ independently are selected from the group consisting of hydrogen (H), hydroxyl (OH), C₁₋₆-alkyl and C₁₋₆-alkoxy, provided that at least one of R₁, R₂ and R₃ is hydroxyl (OH), and R₄ is selected from the group consisting of hydrogen (H) and C₁₋₆-alkyl.

Some of the preferred substituents are the following: R₂ is hydroxyl (OH) or sulfoxy (O—SO2-OH), R₁ is OCH₃ (methoxy), R₃ is hydrogen (H) or OCH₃ (methoxy) and R₄ is hydrogen (H). In one embodiment said hydroxycinnamic acid or a derivative thereof is zosteric acid. In another embodiment said hydroxycinnamic acid or a derivative thereof is selected from the group consisting of caffeic acid, ferulic acid, sinapic acid and para-coumaric acid.

WO16008886A1 describes biological processes for the production of hydroxycinnamic acids using polypeptides having tyrosine ammonia lyase activity. WO16026976A1 and WO17144671A1 describes several biological processes for the production of aryl sulphates, including hydroxycinnamic acid derivatives.

Crops, seeds and fruits are typically sprayed with the antifungal composition. However, seeds and post-harvest fruits may also be immersed into the antifungal composition or an aqueous dilution thereof. The hydroxycinnamic acid or a derivative thereof may be applied as a mix with at least one other fungicide. The hydroxycinnamic acid or a derivative thereof may also be applied in a rotational program with at least one other fungicide.

Hydroxycinnamic acid or a derivative thereof may be applied e.g. to crops to prevent a fungal and/or oomycetes pest. Examples of such crops where the application of hydroxycinnamic acid or derivatives thereof may be used against fungal and/or oomycetes pests are e.g. grape vine, potatoes and tobacco. Further crops where the use of the present invention is applicable is e.g. wheat, oat, rye, corn, rice and other grains. Still further crops where the hydroxycinnamic acid and derivatives thereof may be used to protect against a fungal and/or oomycetes pest are barley, oilseed rape, sugar beet, soybean, cocoa, coffee, cotton, grass, sugarcane, banana, vegetables and potted plants.

The hydroxycinnamic acid or a derivative thereof is preferably applied to the leaves of said crops, such as by spraying.

Hydroxycinnamic acid or a derivative thereof may be applied e.g. to seeds to prevent a fungal and/or oomycetes pest, e.g. as a seed dressing. Examples of seeds where hydroxycinnamic acid and derivatives thereof may be applied to prevent fungal and/or oomycetes pest is wheat, oat, rye, corn, rice or another grain. Still further seeds where hydroxycinnamic acid and derivatives thereof may be used to protect against fungal and/or oomycetes pest are beans, oilseed rape, sugar beet and soybean.

Hydroxycinnamic acid or a derivative thereof may be applied e.g. to fruits to prevent a fungal and/or oomycetes pest. Examples of fruits where hydroxycinnamic acid and derivatives thereof may be applied to prevent fungal and/or oomycetes pest is apples, pears, prunes and citrus fruits. It is to be understood that the hydroxycinnamic acid and derivatives thereof can be used for fruits both pre-harvest and post-harvest.

Fungal and/or Oomycetes Pests.

There are a number of fungal and/or oomycetes pests that thrive on crops, seeds and fruits. Those fungal and/or oomycetes pests may hamper or eliminate the germination, growth or product formation to have an immense negative impact on agriculture.

In grape vines (Vitis vinifera) some fungal and/or oomycetes pests that cause problems are Uncinula necator, Plasmopara viticola (downy mildew), Botrytis cinerea and Erysiphe necator.

For wheat typical fungal and/or oomycetes pests are Puccinia spp., Blumeria graminis, Zymoseptoria tritici, Fusarium spp., Pyrenophora tritici repentis, Oculimacula spp., Ustilago spp., Tilletia spp. Parastagonospora nodorum and Claviceps purpurea.

For barley (Hordeum vulgare) some fungal and/or oomycetes pests are Puccinia spp., Blumeria graminis, Pyrenophora teres, Rhynchosporium commune, Claviceps purpurea, Ustilago nuda and Pyrenophora graminea.

For oat (Avena sativa) some fungal and/or oomycetes pests that hamper agriculture are Puccinia corona, Blumeria graminis, Pyrenophora avenae and Ustilago avenae.

For rye (Secale cereale) some fungal and/or oomycetes pests that hamper agriculture are Puccinia spp., Blumeria graminis, Rhynchosporium secale and Claviceps purpurea.

For maize (Zea mays). Some fungal and/or oomycetes pests that hamper agriculture are Kabatiella zeae, Fusarium spp., Setosphaeria turcica, Phytophthora, Pythium, Colletotrichum graminicola, Puccinia polysora, Sphacelotheca reiliana and Ustilago maydis.

For rice (Oryza sativa) some fungal and/or oomycetes pests are Pyricularia oryzae, Rhizoctonia solani, Cochliobolus miyabeanus, Villosiclava virens, Magnaporthe grisea and Piricularia oryzae. For potato (Solanum tuberosum) some fungal and/or oomycetes pests are Alternaria spp., Phytophthora spp., Phytophthora infestans, Cercospora spp. Colletotrichum coccodes, Puccinia pittieriana, Macrophomina phaseolina, Fusarium spp. and Botrytis cinerea.

For oilseed rape (Brassica napus) some fungal and/or oomycetes pests are Sclerotinia sclerotiorum, Alternaria spp., Pyrenopeziza brassicae, Plenodomus lingam and Leptosphaeria maculans.

For sugar beet (Beta vulgaris) some fungal and/or oomycetes pests are Cercospora beticola and other Cercospora spp., Erysiphe betae, Uromyces betae and Ramularia beticola.

For banana (Musa ssp.) some fungal and/or oomycetes pests are Pseudocercospora fijiensis, Fusarium oxysporum, Pseudocercospora musae, Colletotrichum musae and Mycosphaerella spp. Some typical fungal and/or oomycetes pests for sugarcane (Saccharum officinarum) are Bipolaris sacchari, Puccinia kuehnii and Sporisorium scitaminies.

For soybean (Glycine max) e.g. soybeen seeds some typical fungal and/or oomycetes pests are Phakopsora pachyrhizi, Phytophthora sojae, Pythium, Cercospora kikuchii and Corynespora cassiicola.

For grass, such as that grown on golf courses, some typical fungal and/or oomycetes pests are Microdochium nivale, Rizoctonia solani, Colletothrichum cereale, Clarirededia jacksonil and Magnaporthiopsis poae.

For vegetables some fungal and/or oomycetes pests are powdery mildew (Sphaerotheca fuliginea), early blight (Verticillium spp.) and damping off (Pythium spp.).

A typical fungal and/or oomycetes pest for cocoa (Theobroma cacao) is black pod (Phytophthora palmivora).

For coffee (Coffea ssp.) a typical fungal and/or oomycetes pest is leaf rust (Hemileia vastatrix) and berry disease (Colletotrichum coffeanum).

For cotton (Gossypium spp.) some fungal and/or oomycetes pests are Macrosporiosis (Alternaria macrospora) or seedling disease complex.

For potted plants some fungal and/or oomycetes pests are Erysiphe spp. and Puccinia spp.

For apple (Malus domestica) some fungal and/or oomycetes pests are Venturia inaequalis, Monilia digitata, Podesphaera leucotricha, Botrytis cinerea (grey mould), Penicillium expansum (bluish-green mold), Rhizopus stolonifer (soft rot), Gloeosporium album (bull's eye rot) and Stemphylium vesicarium (pear brown spot).

For pear (Pyrus communis) some fungal and/or oomycetes pests are Ventura Perina, Botrytis cinerea (grey mould), Penicillium expansum (bluish-green mold), Rhizopus stolonifer (soft rot), Gleosporium album (bull's eye rot) and Stemphylium vesicarium (pear brown spot).

For Prunus avium or other Prunus spp. Some fungal and/or oomycetes pests are Podosphaera spp., Apiosporina morbosa, Monilinia spp (Brown rot) or Alternaria alternata (Alternaria rot).

For Citrus sinensis or other Citrus spp. some fungal and/or oomycetes pests are Penicillium digitatum, Penicillium italicum, Penicillium expansum (Bluish-green mold), Elsinor fawcettii, Alternaria spp. or Geotrichum candidum.

### Antifungal Compositions.

In a second aspect the present invention provides biofungicide compositions comprising hydroxycinnamic acid or a derivative thereof in a concentration from about 0.1% w/w to about 10% w/w, water and optionally a preservative.

In an embodiment the hydroxycinnamic acid or a derivative thereof is said hydroxycinnamic acid or a derivative thereof is

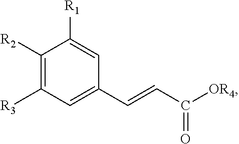

wherein R₁, R₂ and R₃ independently are selected from the group consisting of hydrogen (H), hydroxyl (OH), C₁₋₆-alkyl and C₁₋₆-alkoxy, provided that at least one of R₁, R₂ and R₃ is hydroxyl (OH), and R₄ is selected from the group consisting of hydrogen (H) and C₁₋₆-alkyl.

In an embodiment R₂ is hydroxyl (OH). In another embodiment R₂ is sulfoxy (O—SO2-OH). In yet another embodiment R₁ is OCH₃ (methoxy). In yet another embodiment R₃ is hydrogen (H).

In yet another embodiment R₃ is OCH₃ (methoxy). In yet another embodiment R₄ is hydrogen (H).

In yet another embodiment the hydroxycinnamic acid or a derivative thereof is zosteric acid.

In yet another embodiment the hydroxycinnamic acid or a derivative thereof is selected from the group consisting of caffeic acid, ferulic acid, isoferulic acid, sinapic acid and para-coumaric acid. In a further embodiment, R₁ is O—SO₂—OH and R₂ is OCH₃.

Preservatives may be any suitable compound or mixtures thereof which prevent or delay microbial degradation of the biofungicide compositions during the period between manufacture of the antifungal composition and the use of the antifungal composition for application to crops, seeds or fruits, e.g. during product storage and distribution. Preservatives mainly serves as bactericides.

It is to be understood that the preservative must be compatible with the use for application to crops, seeds and fruits, of which some may be intended as food products.

Preservatives are primarily incorporated to prevent deterioration of sensitive formulation components such as rheological modifiers, and to prevent formation of microbial slimes which can clog spray nozzles. The requirements imposed on preservatives include: Broad spectrum antimicrobial activity, non-reactivity with other formulation components in the composition, low phytotoxicity and mammalian toxicity, high temperature stability, environmental safety, and broad regulatory approvals.

### Definitions

The term “crops” as used herein is intended to mean a plant that can be grown and harvested extensively for either profit or subsistence. Such a plant is normally cultivated in large numbers at one place on a large scale. Most crops are cultivated in agriculture or aquaculture Non-limiting examples of crops are wheat, rice, potatoes, vegetables, fruit trees, cut cultivated flowers and medicinal plants. Crops may also include macroscopic fungus (e.g. mushrooms) and marine macroalga (e.g. seaweed). Further examples of crops include corn and soybean. Yet further examples of crops include pulses, such as lentils, peas, beans, faba beans, Bambara beans, vetches, and lupins.

The term “seeds” as used herein is intended to mean an embryonic plant enclosed in a protective outer covering, along with a food reserve. Seeds typically include what can be sown to grow a plant, tree or the like. Non-limiting examples of seeds are wheat, sugar beet and potatoes. Further non-limited examples include corn and soybean.
The term “fruits” as used herein is intended to mean the seed-bearing structure in flowering plants that is formed from the ovary after flowering. Fruits are the means by which flowering disseminate their seeds. Non-limiting examples of fruits are apples and lemons.

The term “biopesticide” as used herein is intended to mean a certain type of pesticides for example derived from such natural materials as animals, plants, bacteria, and certain minerals. Biopesticides include e.g. naturally occurring substances that control pests (biochemical pesticides) and microorganisms that control pests (microbial pesticides). Biopesticides have usually no known function in photosynthesis, growth or other basic aspects of plant physiology. Instead, they are active against biological pests. Non-limiting examples of biopesticides with fungicide effects are Capsaicin, a compound from chili peppers, and rosemary and peppermint oil that also work as fungicides, and the microbes like Streptomyces lydicus (tradename Actinovate) that work against diseases like powdery mildew, downy mildew and botrytis in vine and other crops.

The term “biofungicide” as used herein is intended to mean a type of fungicide which may be derived from natural materials as animals, plants, bacteria and certain minerals. Biofungicides include e.g. fungicides derived from natural materials as well as obtained by other sources. A non-limiting example of a biofungicide is zosteric acid which is naturally occurring in the plant eelgrass (zostera marina). Further, the term “biofungicide” should be understood to cover any agent that inhibits the proliferation of phytopathogens.

The term “pests” as used herein refer to organisms that cause diseases in plants, but can also encompass any unwanted organisms that negatively affect plant health, reduce yield, compromise the quality of harvested produce, or hinder the plant's growth and development. The impact of pests can manifest as direct damage to the plant tissues, or indirectly, by acting as vectors for disease-causing pathogens.

The term “protecting” as used herein refers to prevention, inhibition, neutralization, and/or effective management of the development, propagation, and detrimental consequences posed by phytopathogens on a given plant or a product procured therefrom. This encompassing protection is devised to extend its coverage over various pivotal stages within the lifecycle of phytopathogens, inclusive of their spores and mycelium. In some aspects of the present disclosure, “protecting” and “protects” are used interchangeably with the term “inhibiting proliferation”.

The term “inhibiting proliferation” as used herein pertains to killing, constraining, suppressing, and/or impeding the growth, reproduction, and dissemination of phytopathogens, encompassing both fungal and oomycetes. The inhibition takes effect across an assortment of pivotal phases in the lifecycle of these phytopathogens, extending from their initial reproductive activities, through intermediate stages of growth, and continuing into their eventual propagation.

The term “biobased” as used herein is used to characterize biobased products wherein:
a) the total carbon content of the product is at least 30%, and
b) the carbon content of a renewable raw material (biobased) is at least 20%.

As recognized by the Circular Bio-based Europe Joint Undertaking (CBE Joint Undertaking) established in 2021, developing biobased materials is essential if the EU is to reach its climate targets as set out in the European Green Deal.

Both fossil and renewable raw materials consist mainly of carbon (C). Carbon occurs in several isotopes. Isotope ¹⁴C is radioactive and occurs naturally in all living organisms (plants, animals, etc.) in a fixed relative concentration which is nearly identical to the relative ¹⁴C concentration in the atmosphere. At this concentration, the radioactivity level of ¹⁴C is 100%. Once an organism is no longer living, this concentration, and thus the radioactivity rate, decays with a half-life of approximately 5700 years. The radioactive ¹⁴C level of an unknown substance can therefore help determine how old the carbon contained in the substance is.

“Young” carbon (0 to 10 years) derived from renewable raw materials, such as plants or animals, has a relative isotope ¹⁴C concentration which is nearly identical to the relative ¹⁴C concentration in the atmosphere and the radioactive ¹⁴C level of such young carbon is thus about 100%.

“Old” carbon (millions of years) derived from synthetic or fossil (petrochemical) sources is greatly depleted from isotope ¹⁴C as the age of such synthetic and fossil sources far exceeds the half-life of isotope ¹⁴C which is approximately 5700 years. Hence, carbon derived from synthetic or fossil sources has a relative isotope ¹⁴C concentration around 0% and the radioactive ¹⁴C level of such old carbon is thus about 0%.

In one embodiment the term “radioactive ¹⁴C level” refer to the total radioactive ¹⁴C level of a given substance, product, or composition, as defined above.

The isotope ¹⁴C method may be used to determine the concentration of young (renewable) materials in comparison with the concentration of old (fossil) resources. The carbon content of a renewable raw material is referred to as the “biobased carbon content”. The carbon content of a renewable raw material or the “biobased carbon content” may be determined as described below.

When measuring the biobased carbon content, the result may be reported as “% biobased carbon”. This indicates the percentage carbon from “natural” (plant or animal by-product) sources versus “synthetic” or “fossil” (petrochemical) sources. For reference, 100% biobased carbon indicates that a material is entirely sourced from plants or animal by-products and 0% biobased carbon indicates that a material did not contain any carbon from plants or animal by-products. A value in between represents a mixture of natural and fossil sources.

### Oomycetes and Fungi

In some embodiments, the present disclosure provides protection of crops, seeds, and fruits against fungal pests. In some embodiments, the present disclosure provides protection against oomycetes and diseases resulting from oomycetes. The Oomycetes are a class of filamentous, eukaryotic microorganisms that include some of the most devastating plant and animal pathogens.

Oomycetes are members of the Kingdom Chromista and stramenopiles lineage of the stramenopiles-alveolata-rhizaria eukaryotic supergroup, with close relationships to the diatoms and brown algae. On the other hand, fungi belong to the Kingdom Fungi or Eumycota.

Adaptations of both Oomycetes and Fungi to obtaining their nutrients by absorption have resulted in considerable morphological convergence. As a result, Oomycetes resemble fungi in terms of their morphology, filamentous growth, ecological niches, and modes of nutrition.

Despite their extensive similarities, however, the evolutionary relationship between oomycetes and fungi represents one of the most distantly related evolutionary groupings within the eukaryotes.

Accordingly, Oomycetes and fungi differ in several basic properties including sexual reproduction, nuclear state of vegetative mycelium, cell wall composition, type of flagella on zoospores and morphology of mitochondrial cristae. Understanding their evolutionary relationships contribute to our ability to develop strategies to control the diseases they cause.

Oomycetes represent one of the biggest threats to worldwide food security and natural ecosystems.

Even within the oomycete class, there are a number of highly diverse orders, including the Peronosporales, Pythiales, Albuginales, and Saprolegniales orders. There is significant diversity both between and within these orders in terms of lifestyle, pathogenicity, and host range.

Current widely used control measures for Oomycetes-caused crop diseases include a) multi-site actives with broad target scope (FRAC classes M) e.g. Copper products and Mancozeb which are under regulatory pressure or already being phased out in certain regions, as well as b) single-site actives which are subject to rapid resistance development in target organisms.

Therefore, there is a need to find new more environmentally acceptable multi-site actives with low risk of resistance development to replace current multi-site products both as a) solo-ingredients in future crop protection products; and as b) active ingredient mix-partners (whether tank-mix or ready-mix) as tools for managing resistance development against available single-site actives.

In some embodiments, the present disclosure provides a hydroxycinnamic acid or a derivative thereof, for example zosteric acid for controlling oomycetes and protecting crops, fruits, and/or seeds.

### Application

In some embodiments, the present disclosure provides a use of a composition comprising hydroxycinnamic acid or a derivative thereof for protection of crops, seeds or fruits against at least one phytopathogen, wherein the composition is applied to the surface of said crops, seeds or fruits.

In some embodiments, the composition is applied to the surface of said crops, seeds, or fruits by spraying or by immersion into said composition. In some embodiments, the composition is applied by spraying.

In some embodiments, the composition is applied to fruits post-harvest. In some embodiments, the composition is applied as a liquid composition comprising the hydroxycinnamic acid or a derivative thereof in a concentration from about 0.1% w/w to about 10% w/w, water and a preservative.

### Phytopathogens

In some embodiments, at least one phytopathogen is an oomycete or a fungus. In some embodiments, at least one phytopathogen is an oomycete.

In some embodiments, at least one phytopathogen is an oomycete of an order selected from the group consisting of: peronosporales, pythiales, albuginales, and saprolegniales.

In some embodiments, at least one phytopathogen is an oomycete selected from the group consisting of: Achlya spp., Aphanomyces spp., Bremia lactucae, Halophytophthora spp., Lagenidium spp., Olpidiopsis spp., Phytopythium spp., Plasmoverna spp., Pseudoperonospora spp., Saprolegnia spp., Synchytrium spp., and Trogoderma spp.

In some embodiments, at least one phytopathogen is an oomycete selected from the group consisting of: Peronospora spp., such as Peronospora destructor or Peronospora tabacina; and Plasmopara spp., such as Plasmopara viticola.

In some embodiments, at least one phytopathogen is a fungus.

### Diseases

Use of a composition of the present disclosure protects against diseases, such as diseases resulting from fungi or oomycetes. The present disclosure is particularly relevant for protecting crops, seeds, and/or fruits against such diseases.

In some embodiments, the composition protects against a disease selected from the group consisting of downy mildew, such as downy mildew caused by Peronospora spp.; powdery mildew, such as powdery mildew caused by Podosphaera aphanis; late blight, such as late blight caused by Phytophthora infestans; Asian soy rust, such as Asian soy rust caused by Phakopsora pachyrhizi Pythium root rot, such as Pythium root rot caused by Pythium spp.; damping-off; white rust diseases, such as white rust diseases caused by oomycetes of the order Albuginales; Sclerophthora macrospora blight, and Plasmopara viticola causing downy mildew in grapevines.

In some embodiments, the composition protects against downy mildew caused by Plasmopara viticola.

In some embodiments, the composition protects against bunt of wheat and/or Barley stripe.

In some embodiments, the composition protects against an ascomycetous fungus. In some embodiments, the composition protects against the ascomycetous fungus Podosphaera aphanis, in particular on strawberries, optionally having developed symptoms of powdery mildew.

### Crops, Seeds, and Fruits

In some embodiments, the composition is advantageous for protection of crops, seeds, and/or fruits against fungal and/or oomycetes pests such as to avoid developing diseases, such as the diseases specified herein.

In some embodiments, the crops are selected from the group consisting of: grapes, such as grape vines, potatoes, tomatoes, lettuce, onions, tobacco, cucurbits, cruciferous vegetables, spinach, and soybeans.

In some embodiments, the crops are wine grapes.

In some embodiments, the crops are grape vines (Vitis vinifera) and the use protects against downy mildew (Plasmopara viticola).

In some embodiments, the crops are potatoes and the use protects against late blight of potato (Phytophthora infestans).

In some embodiments, the seeds are selected from the group consisting of: wheat, oat, rye, corn, rice, cucumber seeds, melon seeds, squash seeds, soybean, and pumpkin seeds.

In some embodiments, the fruits are selected from the group consisting of: grapes, such as grape clusters and fruits of grape, strawberries, raspberries, and blueberries.

In some embodiments, the use protects against downy mildew caused by Plasmopara viticola in grapes, such as grapevines.

In some embodiments, the use protects against Tilletia caries and the crops or seeds are wheat (Triticum aestivum).

In some embodiments, the use protects against Pyrenophora graminea and the crops are Barley (Hordeum vulgare).

### Hydroxycinnamic Acid and Derivatives

It has previously been demonstrated by Cattò et al 2015 (PLoS ONE 10(7): e0131519) that the cis-isomer of zosteric acid has no activity against bacterial biofilm produced by E. coli, whereas the corresponding trans-isomer of zosteric acid was highly effective. Thus, in one aspect the present disclosure provides hydroxycinnamic acid or derivatives thereof, such as zosteric acid wherein the double bond of the α,β-unsaturation is in trans-configuration. In particular, the hydroxycinnamic acid or derivative thereof can be in a salt form, such as an alkali metal salt form. In one embodiment, the hydroxycinnamic acid or derivative thereof is a sodium salt or a potassium salt.

In some embodiments, the hydroxycinnamic acid or derivative thereof is zosteric acid and the salt is sodium or potassium, such as monosodium or monopotassium.

In some embodiments, the hydroxycinnamic acid or a derivative thereof is

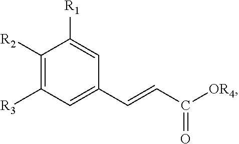

or a salt thereof,
wherein R₁, R₂ and R₃ independently are selected from the group consisting of hydrogen (H), hydroxyl (OH), C₁₋₆-alkyl and C₁₋₆-alkoxy, —O—SO₂—OR₅, wherein R₅ is selected from the group consisting of: hydrogen and C₁₋₆-alkyl;
provided that at least one of R₁, R₂ and R₃ is hydroxyl (OH) or —O—SO₂—OR₅, and R₄ is selected from the group consisting of hydrogen (H) and C₁₋₆-alkyl.

In some embodiments, R₂ is —O—SO₂—OR₅.

In some embodiments, R₂ is —O—SO₂—OR₅ and R₅ is hydrogen.

In some embodiments, R₁ is —O—SO₂—OR₅.

In some embodiments, R₁ is —O—SO₂—OR₅ and R₅ is hydrogen. In some embodiments, R₁ and R₂ are O—SO₂—OR₅.

In some embodiments, the hydroxycinnamic acid or derivative thereof is zosteric acid.

### Specific Treatments Aspects

In some embodiments, the present disclosure provides a method wherein the concentration of the hydroxycinnamic acid or derivative thereof is selected so that optimal efficacy is achieved against the phytopathogen without becoming toxic. In some embodiments, the concentration is from about 0.1% w/w to about 10% w/w, for example from 0.1% w/w to 0.5% w/w, such as from 0.5% w/w to 1.0% w/w, such as from 1.0% w/w to 1.5% w/w, such as from 1.5% w/w to 2.0% w/w, such as from 2.0% w/w to 2.5% w/w, such as from 2.5% w/w to 3.0% w/w, such as from 3.0% w/w to 3.5% w/w, such as from 3.5% w/w to 4.0% w/w, such as from 4.0% w/w to 4.5% w/w, such as from 4.5% w/w to 5.0% w/w, such as from 5.0% w/w to 5.5% w/w, such as from 5.5% w/w to 6.0% w/w, such as from 6.0% w/w to 6.5% w/w, such as from 6.5% w/w to 7.0% w/w, such as from 7.0% w/w to 7.5% w/w, such as from 7.5% w/w to 8.0% w/w, such as from 8.0% w/w to 8.5% w/w, such as from 8.5% w/w to 9.0% w/w, such as from 9.0% w/w to 9.5% w/w, such as from 9.5% w/w to 10% w/w.

In some embodiments, the method is provided wherein:
a) the hydroxycinnamic acid or derivative thereof is zosteric acid,
b) the concentration of zosteric acid is from 0.5% to 3.0% w/w, for example 1% w/w;
c) the plant or product derived therefrom is grapes; and
d) the phytopathogen is plasmopara viticola, optionally present with symptoms of downy mildew.

In some embodiments, the method is provided wherein:
a) the hydroxycinnamic acid or derivative thereof is zosteric acid,
b) the concentration of zosteric acid is from 0.1% to 6% w/w, for example from 3 to 6%, such as from 4 to 5% w/w, such as 5% w/w;
c) the plant or product derived therefrom is potato; and
d) the phytopathogen is Solanum tuberosum, variety Venezia, optionally present with symptoms of potato blight.

In some embodiments, the method is provided wherein:
a) the hydroxycinnamic acid or derivative thereof is zosteric acid,
b) the concentration of zosteric acid is from 0.1% to 3% w/w, for example from 0.5% to 2%, such as from 0.8% to 1.5% w/w, such as 1% w/w;
c) the plant or product derived therefrom is wheat or barley; and
d) the phytopathogen is tilletia caries, optionally present with symptoms of bunt of wheat, or Pyrenophora graminea, optionally present with symptoms of Barley stibe.

In some embodiments, the method is effective against Phytophthora and Pythium, for example in the context of maize seed treatment.

In some embodiments, the method is effective against Phytophthora sojae and Pythium, for example in the context of soybeen seed treatment.

In some embodiments, the method protects against powdery mildew in strawberries, for example strawberries of the Fragaria species.

In some embodiments, the method is provided wherein:
a) the hydroxycinnamic acid or derivative thereof is zosteric acid,
b) the concentration of zosteric acid is from 0.1% to 3% w/w, for example from 0.5% to 2%, such as from 0.8% to 1.5% w/w, such as 1% w/w;
c) the plant or product derived therefrom is a strawberry; and
d) the phytopathogen is Podosphaera aphanis, optionally present with symptoms of powdery mildew.

In some embodiments, the method is provided wherein:
a) the hydroxycinnamic acid or derivative thereof is zosteric acid,
b) the concentration of zosteric acid is from 0.1% to 9% w/w, for example from 0.5% to 2%, such as from 0.8% to 1.5% w/w, such as 1% w/w;
c) the plant or product derived therefrom is a strawberry; and
d) the phytopathogen is Podosphaera aphanis, optionally present with symptoms of powdery mildew.

### Compositions

In some embodiments, the present disclosure provides a composition comprising a hydroxycinnamic acid or derivative thereof according to the formula:

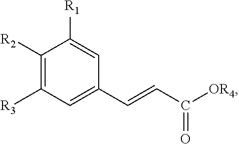

or a salt thereof,
wherein R₁, R₂ and R₃ independently are selected from the group consisting of hydrogen (H), hydroxyl (OH), C₁₋₆-alkyl and C₁₋₆-alkoxy, —O—SO₂—OR₅, wherein R₅ is selected from the group consisting of: hydrogen and C₁₋₆-alkyl;
provided that at least one of R₁, R₂ and R₃ is hydroxyl (OH) or —O—SO₂—OR₅, and R₄ is selected from the group consisting of hydrogen (H) and C₁₋₆-alkyl.

In some embodiments, the composition is provided wherein R₂ is —O—SO₂—OR₅. In some embodiments, R₂ is —O—SO₂—OR₅ and R₅ is hydrogen. In some embodiments, the composition is provided wherein the hydroxycinnamic acid or derivative thereof is zosteric acid.

In some embodiments, the composition is a biofungicide.

In some embodiments, the composition comprises the hydroxycinnamic acid or derivative thereof in a concentration from about 0.1% w/w to about 10% w/w, water and optionally a preservative. This present disclosure demonstrates that this concentration range has shown to provide an optimal balance between efficacy against the pathogen and phytotoxicity to the plant.

In some embodiments, the composition comprises the hydroxycinnamic acid or derivative thereof with a trans/cis-ratio of at least 90:10, such as at least 91:9, such as at least 92:8, such as at least 93:7, such as at least 94:6, such as at least 95:5, such as at least 96:4, such as at least 97:3, such as at least 98:2, such as at least 99:1, for example 100:0. As disclosed herein, the activity resides with the trans-isomer and consequently a composition comprising very high amounts of the trans-isomer and close to none or none of the cis-isomer will provide a more efficient composition.

In some embodiments, the composition is a biobased composition.

In some embodiments, the composition comprises at least 20% biobased carbon, such as at least 30% biobased carbon, such as at least 40% biobased carbon, such as at least 50% biobased carbon, such as at least 60% biobased carbon, such as at least 70% biobased carbon, such as at least 75% biobased carbon, such as at least 80% biobased carbon, such as at least 85% biobased carbon, such as at least 90% biobased carbon, such as at least 95% biobased carbon, such as 100% biobased carbon.

In some embodiments, the composition comprises from 20% to 100% biobased carbon, such as from 30% to 100% biobased carbon, such as from 40% to 100% biobased carbon, such as from 50% to 100% biobased carbon, such as from 60% to 100% biobased carbon, such as from 70% to 100% biobased carbon, such as from 75% to 100% biobased carbon, such as from 80% to 100% biobased carbon, such as from 85% to 100% biobased carbon, such as from 90% to 100% biobased carbon, such as from 95% to 100% biobased carbon, such as 100% biobased carbon.

In some embodiments, a crop is provided comprising the composition as defined herein. In some embodiments, a fruit is provided comprising the composition as defined herein. In some embodiments, a seed is provided comprising the composition as defined herein.

In some embodiments, a suspension of zosteric acid monopotassium is provided, optionally in an aqueous solution.

In some embodiments, a suspension of zosteric acid dipotassium or zosteric acid disodium is provided, optionally in an aqueous solution.

### Items

The present invention may be summarized by the following items:
1. Use of hydroxycinnamic acid or a derivative thereof for protection of crops, seeds or fruits against at least one fungal pest, wherein a composition comprising hydroxycinnamic acid or a derivative thereof is applied to the surface of said crops, seeds or fruits by spraying or by immersion into said composition.
2. The use according to item 1, wherein said hydroxycinnamic acid or a derivative thereof is applied as a liquid composition comprising hydroxycinnamic acid or a derivative thereof in a concentration from about 0.1% w/w to about 10% w/w, water and a preservative.
3. The use according to any of items 1-2, wherein hydroxycinnamic acid or a derivative thereof is applied as a mix with at least one other fungicide.
4. The use according to any of items 1-3, wherein hydroxycinnamic acid or a derivative thereof is applied in a rotational program with at least one other fungicide.
5. The use according to any of items 1-4, wherein hydroxycinnamic acid or a derivative thereof is applied to crops.
6. The use according to any of items 1-5, wherein said crops is selected from grape vine, potatoes and tobacco plants.
7. The use according to any of items 1-6, wherein hydroxycinnamic acid or a derivative thereof is applied to the leaves of said crops.
8. The use according to any of items 1-4, wherein said hydroxycinnamic acid or a derivative thereof is applied to seeds, i.e. as a seed dressing.
9. The use according to item 8, wherein said seeds are immersed into said composition comprising hydroxycinnamic acid or a derivative thereof.
10. The use according to item 8, wherein said seeds are sprayed by said composition comprising hydroxycinnamic acid or a derivative thereof.
11. The use according to any of items 8-10, wherein said seeds are selected from the group consisting of wheat, oat, rye, corn, rice or another grain.
12. The use according to item 11, wherein said seeds are selected from the group consisting of wheat, oat, rye, corn and rice.
13. The use according to item 12, wherein said seeds are wheat.
14. The use according to item 12, wherein said seeds are oat.
15. The use according to item 12, wherein said seeds are rye.
16. The use according to item 12, wherein said seeds are corn.
17. The use according to item 12, wherein said seeds are rice.
18. The use according to any of items 8-10, wherein said seeds are beans.
19. The use according to item 6, wherein said seeds are sprayed by said composition comprising hydroxycinnamic acid or a derivative thereof.
20. The use according to any of items 1-19, wherein hydroxycinnamic acid or a derivative thereof is applied to fruits.
21. The use according to item 20, wherein hydroxycinnamic acid or a derivative thereof is applied to fruits pre-harvest.
22. The use according to item 20, wherein hydroxycinnamic acid or a derivative thereof is applied to fruits post-harvest.
23. The use according to any of items 20 and 22, wherein said fruits are immersed into said composition comprising hydroxycinnamic acid or a derivative thereof.
24. The use according to any of items 1-23, wherein said composition comprising hydroxycinnamic acid or a derivative thereof is applied by spraying.
25. The use according to any of items 1-24, wherein said fungal pest is Uncinula necator, Plasmopara viticola, Botrytis cinerea or Erysiphe necator.
26. The use according to item 25, wherein said fungal pest is downy mildew (Plasmopara viticola).
27. The use according to any of items 25-26, wherein said crop is grape vines (Vitis vinifera).
28. The use according to any of items 1-24, wherein said fungal pest is late blight of potato (Phytophthora infestans).
29. The use according to item 28, wherein said crop is potato.
30. The use according to any of items 1-24, wherein said fungal pest is selected from the group consisting of Puccinia spp., Blumeria graminis, Zymoseptoria tritici, Fusarium spp., Pyrenophora tritici repentis, Oculimacula spp., Ustilago spp., Tilletia spp. Parastagonospora nodorum and Claviceps purpurea.
31. The use according to item 30, wherein said fungal pest is Tilletia caries.
32. The use according to item 30, wherein said fungal pest is Puccinia striiformis.
33. The use according to any of item 30, wherein said fungal pest is Blumeria graminis.
34. The use according to any of items 30-33, where said crops or seeds are wheat (Triticum aestivum).
35. The use according to any of items 1-24, wherein said fungal pest is Puccinia spp., Blumeria graminis, Pyrenophora teres, Rhynchosporium commune, Claviceps purpurea, Ustilago nuda, Pyrenophora graminea.
36. The use according to item 35, wherein said fungal disease is Pyrenophora graminea.
37. The use according to item 36, wherein said crops are Barley (Hordeum vulgare).
38. The use according to any of items 1-24, wherein said fungal pest is selected from the group consisting of Puccinia corona, Blumeria graminis, Pyrenophora avenae and Ustilago avenae.
39. The use according to item 38, wherein said crops or seeds are oat (Avena sativa).
40. The use according to any of items 1-24, wherein said fungal pest is selected from the group consisting of Puccinia spp., Blumeria graminis, Rhynchosporium secale and Claviceps purpurea.
41. The use according to item 40, wherein said crops or seeds are rye (Secale cereale).
42. The use according to any of items 1-24, wherein said fungal pest is selected from the group consisting of Kabatiella zeae, Fusarium spp., Setosphaeria turcica, Colletotrichum graminicola, Puccinia polysora, Sphacelotheca reiliana and Ustilago maydis.
43. The use according to item 42, wherein said crops or seeds are maize (Zea mays).
44. The use according to any of items 1-24, wherein said fungal pest is selected from the group consisting of Pyricularia oryzae, Rhizoctonia solani, Cochliobolus miyabeanus, Villosiclava virens, Magnaporthe grisea and Piricularia oryzae.
45. The use according to item 44, wherein said crops or seeds are rice (Oryza sativa).
46. The use according to any of items 1-24, wherein said fungal pest is selected from the group consisting of Alternaria spp., Phytophthora spp., Phytophthora infestans, Cercospora spp. Colletotrichum coccodes, Puccinia pittieriana, Macrophomina phaseolina, Fusarium spp. and Botrytis cinerea.
47. The use according to item 46, wherein said fungal pest is Phytophthora infestans.
48. The use according to any of items 46-47, wherein said crops is Potato (Solanum tuberosum).
49. The use according to any of items 1-24, wherein said fungal pest is selected from the group consisting of: Sclerotinia sclerotiorum, Alternaria spp., Pyrenopeziza brassicae, Plenodomus lingam and Leptosphaeria maculans.
50. The use according to item 49, wherein said fungal pest is Plenodomus lingam.
51. The use according to any of items 49-50, wherein said crops or seeds are oilseed rape (Brassica napus).
52. The use according to any of items 1-24, wherein said fungal pest is selected from the group consisting of Cercospora beticola and other Cercospora spp., Erysiphe betae, Uromyces betae and Ramularia beticola.
53. The use according to item 52, wherein said fungal pest is Cercospora beticola.
54. The use according to item 53, wherein said crops or seeds are sugar beet (Beta vulgaris).
55. The use according to any of items 1-24, wherein said fungal pest is selected from the group consisting of Pseudocercospora fijiensis, Fusarium oxysporum, Pseudocercospora musae, Colletotrichum musae and Mycosphaerella spp.
56. The use according to item 55, wherein said crops are Banana (Musa ssp.) 57. The use according to any of items 1-24, wherein said fungal pest is selected from the group consisting of Bipolaris sacchari, Puccinia kuehnii and Sporisorium scitaminies.
58. The use according to item 57, wherein said crops or seeds are sugarcane (Saccharum officinarum).
59. The use according to any of items 1-24, wherein said fungal pest is selected from the group consisting of Phakopsora pachyrhizi, Cercospora kikuchii and Corynespora cassiicola.
60. The use according to item 59, wherein said crops or seeds are Soybean (Glycine max).
61. The use according to any of items 1-24, wherein said fungal pest is selected from the group consisting of Microdochium nivale, Rizoctonia solani, Colletothrichum cereale, Clarirededia jacksonil and Magnaporthiopsis poae.
62. The use according to item 61, wherein said crops is grass, such as golf courses.
63. The use according to any of items 1-24, wherein said fungal pest is selected from the group consisting of Powdery mildew (Sphaerotheca fuliginea), early blight (Verticillium spp.) and damping off (Pythium spp.).
64. The use according to any one of items 1-7 and 63, wherein said crops are vegetables.
65. The use according to any of items 1-24, wherein said fungal pest is Black pod (Phytophthora palmivora).
66. The use according to item 65, wherein said crops is cocoa (Theobroma cacao).
67. The use according to any of items 1-24, wherein said fungal pest is leaf rust (Hemileia vastatrix) or berry disease (Colletotrichum coffeanum).
68. The use according to item 67, wherein said crops is coffee (Coffea ssp.)
69. The use according to any of items 1-24, wherein said fungal pest is Macrosporiosis (Alternaria macrospora) or seedling disease complex.
70. The use according to item 69, wherein said crops are cotton (Gossypium spp.).
71. The use according to any of items 1-24, wherein said fungal pest is Erysiphe spp. or Puccinia spp.
72. The use according to any of items 1-7 and 62, wherein said crops is potted plants.
73. The use according to any of items 1-24, wherein said fungal pest is selected from the group consisting of Venturia inaequalis, Monilia digitata, Podesphaera leucotricha, Botrytis cinerea (grey mould), Penicillium expansum (bluish-green mold), Rhizopus stolonifer (soft rot), Gloeosporium album (bull's eye rot) and Stemphylium vesicarium (pear brown spot),
74. The use according to item 73, wherein said crops are apple (Malus domestica).
75. The use according to any of items 1-24, wherein said fungal pest is selected from the group consisting of Ventura Perina, Botrytis cinerea (grey mould), Penicillium expansum (bluish-green mold), Rhizopus stolonifer (soft rot), Gleosporium album (bull's eye rot) and Stemphylium vesicarium (pear brown spot).
76. The use according to item 75, wherein said crops are pear (Pyrus communis).
77. The use according to any of items 1-24, wherein said fungal pest is Podosphaera spp., Apiosporina morbosa, Monilinia spp (Brown rot) or Alternaria alternata (Alternaria rot).
78. The use according to item 77, wherein said crops are Prunus avium or other Prunus spp.
79. The use according to any of items 1-24, wherein said fungal pest is Penicillium digitatum, Penicillium italicum, Penicillium expansum (Bluish-green mold), Elsinor fawcettii, Alternaria spp. or Geotrichum candidum.
80. The use according to item 79, wherein said crops are Citrus sinensis or other Citrus spp.
81. The use according to any of items 1-24, wherein said fungal pest is Botrytis cinerea (grey mould).
82. The use according to any of the preceding items, wherein said hydroxycinnamic acid or a derivative thereof is

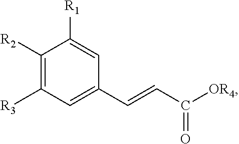

wherein R₁, R₂ and R₃ independently are selected from the group consisting of hydrogen (H), hydroxyl (OH), C₁₋₆-alkyl and C₁₋₆-alkoxy, provided that at least one of R₁, R₂ and R₃ is hydroxyl (OH), and R₄ is selected from the group consisting of hydrogen (H) and C₁₋₆-alkyl.
83. The use according to item 82, wherein R₂ is hydroxyl (OH).
84. The use according to item 82, wherein R₂ is sulfoxy (O—SO2-OH).
85. The use according to any of items 82-84, wherein R₁ is OCH₃ (methoxy).
86. The use according to any of items 82-85, wherein R₃ is hydrogen (H).
87. The use according to any of items 82-85, wherein R₃ is OCH₃ (methoxy).
88. The use according to any of items 82-87, wherein R₄ is hydrogen (H).
89. The use according to any of the preceding items, wherein said hydroxycinnamic acid or a derivative thereof is zosteric acid.
90. The use according to any of items 1-88 wherein said hydroxycinnamic acid or a derivative thereof is selected from the group consisting of caffeic acid, ferulic acid, sinapic acid and para-coumaric acid.
91. The use according to item 90, wherein said hydroxycinnamic acid or a derivative thereof is caffeic acid.
92. The use according to item 90, wherein said hydroxycinnamic acid or a derivative thereof is ferulic acid.
93. The use according to item 90, wherein said hydroxycinnamic acid or a derivative thereof is sinapic acid.
94. The use according to item 90, wherein said hydroxycinnamic acid or a derivative thereof is para-coumaric acid.
95. A biofungicide composition comprising hydroxycinnamic acid or a derivative thereof in a concentration from about 0.1% w/w to about 10% w/w, water and a preservative.
96. The biofungicide composition according to item 95, wherein said hydroxycinnamic acid or a derivative thereof is

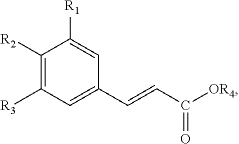

wherein R₁, R₂ and R₃ independently are selected from the group consisting of hydrogen (H), hydroxyl (OH), C₁₋₆-alkyl and C₁₋₆-alkoxy, provided that at least one of R₁, R₂ and R₃ is hydroxyl (OH), and R₄ is selected from the group consisting of hydrogen (H) and C₁₋₆-alkyl.
97. The biofungicide composition according to item 96, wherein R₂ is hydroxyl (OH).
98. The biofungicide composition according to item 96, wherein R₂ is sulfoxy (O—SO2-OH).
99. The biofungicide composition according to any of items 96-98, wherein R₁ is OCH₃ (methoxy).
100. The biofungicide composition according to any of items 96-99, wherein R₃ is hydrogen (H).
101. The biofungicide composition according to any of items 96-99, wherein R₃ is OCH₃ (methoxy).
102. The biofungicide composition according to any of items 96-101, wherein R₄ is hydrogen (H).
103. The biofungicide composition according to item 96, wherein said hydroxycinnamic acid or a derivative thereof is is zosteric acid.
104. The biofungicide composition according to any of items 96-102, wherein said hydroxycinnamic acid or a derivative thereof is selected from the group consisting of caffeic acid, ferulic acid, sinapic acid and para-coumaric acid.
105. The biofungicide composition according to item 104, wherein said hydroxycinnamic acid or a derivative thereof is caffeic acid.
106. The biofungicide composition according to item 104, wherein said hydroxycinnamic acid or a derivative thereof is ferulic acid.
107. The biofungicide composition according to item 104, wherein said hydroxycinnamic acid or a derivative thereof is sinapic acid.
108. The biofungicide composition according to item 104, wherein said hydroxycinnamic acid or a derivative thereof is para-coumaric acid.

### Further Items

1. Use of hydroxycinnamic acid or a derivative thereof for protection of crops, seeds or fruits against at least one fungal pest, wherein a composition comprising hydroxycinnamic acid or a derivative thereof is applied to the surface of said crops, seeds or fruits by spraying or by immersion into said composition.
2. The use according to claim 1, wherein said hydroxycinnamic acid or a derivative thereof is applied as a liquid composition comprising hydroxycinnamic acid or a derivative thereof in a concentration from about 0.1% w/w to about 10% w/w, water and a preservative.
3. The use according to any of claims 1-2, wherein hydroxycinnamic acid or a derivative thereof is applied to crops.
4. The use according to any of claims 1-3, wherein said crops is selected from grape vine, potatoes and tobacco.
5. The use according to any of claims 1-4, wherein said hydroxycinnamic acid or a derivative thereof is applied to seeds, i.e. as a seed dressing.
6. The use according to claim 5, wherein said seeds are selected from the group consisting of wheat, oat, rye, corn, rice and or another grain.
7. The use according to any one of claims 1-3, wherein hydroxycinnamic acid or a derivative thereof is applied to fruits post-harvest.
8. The use according to any of claims 1-7, wherein said composition comprising hydroxycinnamic acid or a derivative thereof is applied by spraying.
9. The use according to any one of claims 1-4, wherein said crops are grape vines (Vitis vinifera) and said fungal pest is downy mildew (Plasmopara viticola).
10. The use according to any of claims 1-4, wherein said crops is potato and said fungal pest is late blight of potato (Phytophthora infestans).
11. The use according to claims 1-2 and 5-6, wherein said fungal pest is Tilletia caries and said crops or seeds are wheat (Triticum aestivum).
12. The use according to any of claims 1-2 and 5-6, wherein said fungal pest is Pyrenophora graminea and said crops are Barley (Hordeum vulgare).
13. The use according to any of the preceding claims, wherein said hydroxycinnamic acid or a derivative thereof is

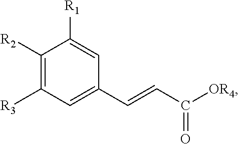

wherein R1, R2 and R3 independently are selected from the group consisting of hydrogen (H), hydroxyl (OH), C1-6-alkyl and C1-6-alkoxy, provided that at least one of R1, R2 and R3 is hydroxyl (OH), and R4 is selected from the group consisting of hydrogen (H) and C1-6-alkyl.
14. The use according to any of the preceding claims, wherein said hydroxycinnamic acid or a derivative thereof is zosteric acid.
15. A biofungicide composition comprising hydroxycinnamic acid or a derivative thereof in a concentration from about 0.1% w/w to about 10% w/w, water and a preservative.

### EXAMPLES

### Materials and Methods

Chemicals used in the examples herein, e.g. for buffers and substrates, are commercial products of at least reagent grade.

### Example 1—Fungicidal Effect of Zosteric Acid Against Downy Mildew in Wine

The fungicidal effect of zosteric acid was tested against downy mildew in grapevine (plasmopara viticola), in standard European grapes (Vitis vinifera). The test was performed as standard controlled environment trials with four replicates for each treatment. Zosteric acid was applied as a formulation containing; zosteric acid (X % depending on the treatment), potassium carbonate (3%), Atlox AL2575 LF (wetting agent, 1%), Silcolapse Clear 30 (antifoam 0.01%) and water. The treatments were applied as a spray to the foliage of the crop using a cabin u-form sprayer operating at 3 bar with a Lechler nozzle type of model 0.2 with four nozzles/rows. The sprayer was operating at a ground speed of 2.25 kilometers per hour and spraying 200 L/ha.

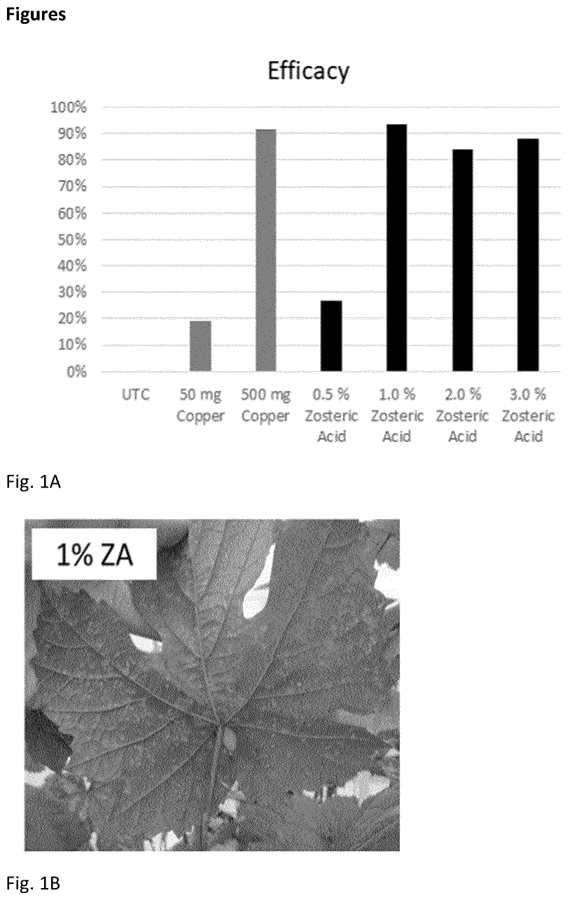

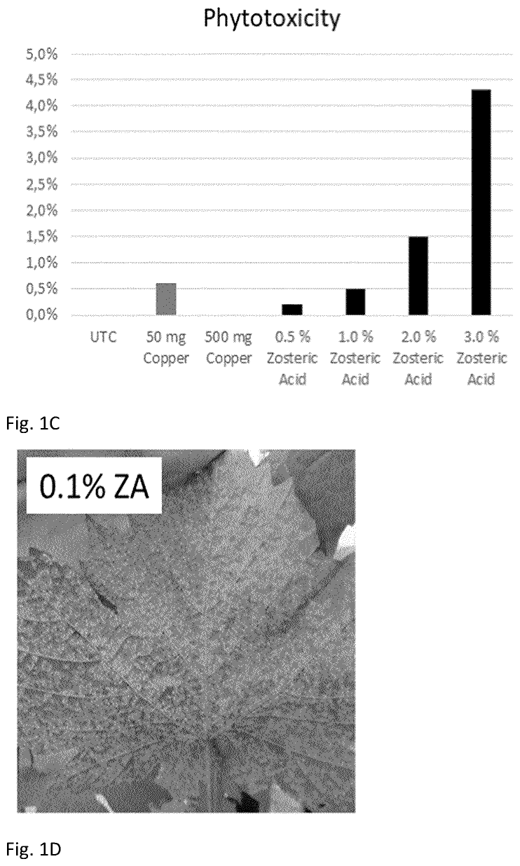

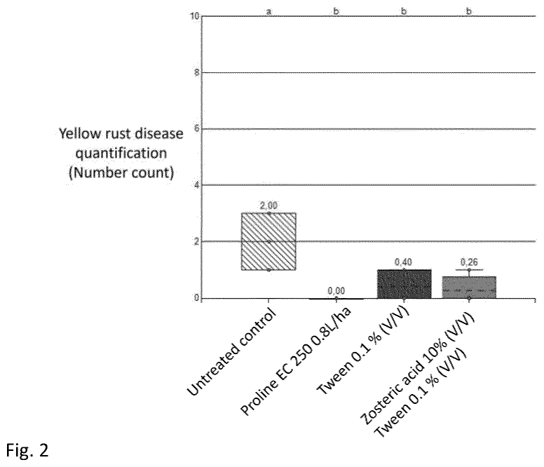

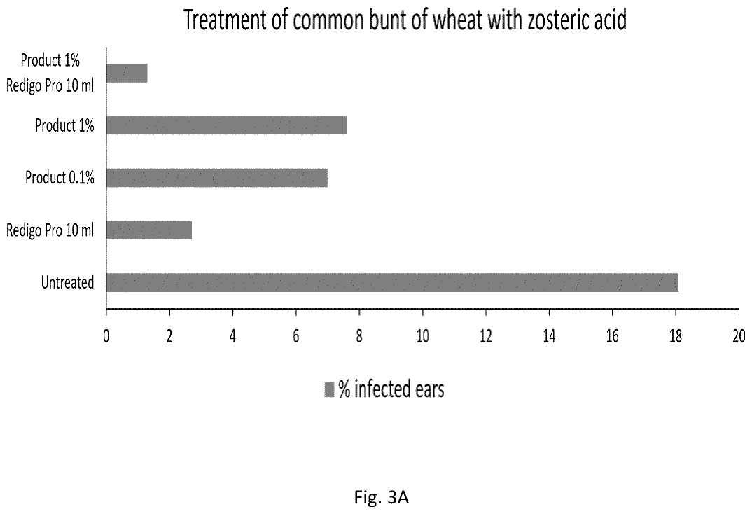

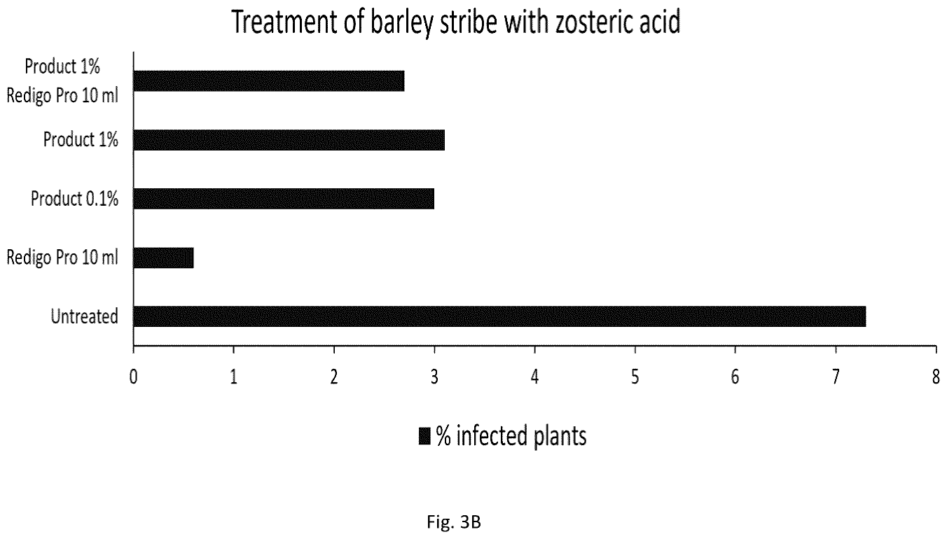

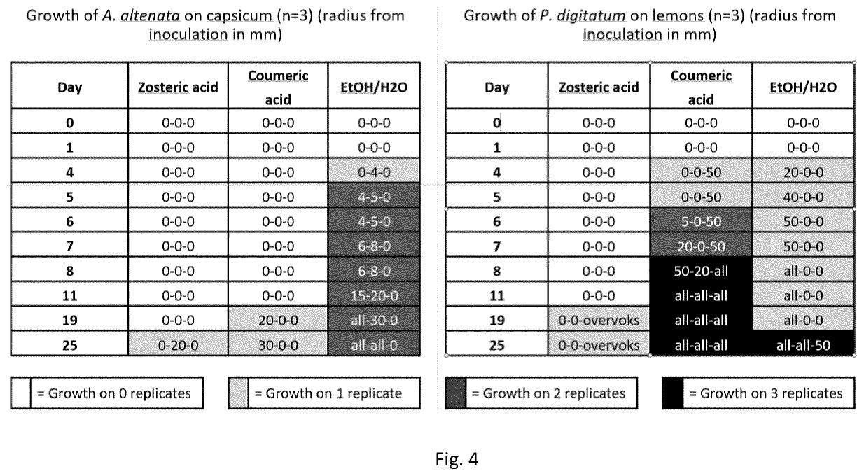

To quantify the fungicidal and phytotoxic effects of the zosteric acids treatments, the disease progression and phytotoxicity were visually evaluated and scored 17 and 13 days, respectively, after application of the treatment. For comparison, an untreated control and a standard fungicide treatment used for downy mildew (currently copper is the standard treatment) was also included in the study design. From the results there is a clear dose response in the zosteric acid treatments, with increasing doses resulting in increased disease control, suggesting that zosteric acid is the active ingredient in the treatments. In addition, the results show that 1% zosteric acid treatment can control the disease at levels similar to a standard fungicide treatment (0.5 grams of copper) (FIG. 1A). At the effective concentration, zosteric acid does not have significant phytotoxic effects and thus does not adversely affect the crop. This combination of efficacy and non-phytotoxicity makes zosteric acid a promising candidate as a fungicide to control downy mildew in grapes.

### Example 2—Fungicidal Effect of Zosteric Acid Against Potato Blight in Potato

To investigate if zosteric acid displayed fungicidal effects against late potato blight (Phytophtora infestans) in potatoes (Solanum tuberosum, variety Venezia) a climate chamber test was conducted. The application was conducted with a Research Track Sprayer and three different concentrations of zosteric acid (0.1%, 1%, and 5%) were sprayed one day before pathogen inoculation and two different concentrations of zosteric acid (1% and 5%) were sprayed after inoculation as soon as the infection got visible. Plants were assessed for phytotoxicity and pest severity 0, 4, and 7 days after the curative application.

As expected, development of late potato blight increased steadily over the assessment period for all treatments. However, treatment of potatoes with 5% zosteric acid and 0.3 L/ha BREAK THRU (wetting agent) reduced pest severity by 7.8%, 7.3% and 6.6% after 0, 4, and 7 days from the curative treatment, which was a significant reduction in pest severity compared to the untreated control. No phytotoxic effects were observed throughout the trials, suggesting that zosteric acid was able to control pest severity without adverse effects on plant health or growth. These results suggest that zosteric acid is an effective fungicide for control of late potato blight in potatoes. One thing to be noted is that, as opposed to the trials conducted against downy mildew in wine (example 1), the late potato blight trials were conducted with an unformulated product and formulation development is expected to increase efficacy substantially.

### Example 3: Zosteric Acid as a Contact Fungicide to Control Yellow Rust in Wheat

A greenhouse trial was conducted to investigate if zosteric acid could be applied as a contact fungicide to control yellow rust in wheat. Wheat was sowed in one-liter pots, with five replicates per treatment. 14 days after sowing, plants were sprayed with 150 L/ha of 10% zosteric acid with 0.1% Tween. For reference, an untreated control, a treatment with 0.1% Tween, and a treatment with a currently used standard fungicide treatment for yellow rust was also included in the test. One day after spraying of the plants, they were inoculated with Puccinia striiformis which is the causative agent of yellow rust. Plants were assessed for attack with yellow rust 13, 19 and 21 days after infection with yellow rust.

Results from the greenhouse trial show that treatment of wheat with 10% zosteric acid and 0.1% Tween drastically reduces the development of yellow rust in wheat. Part of this reduction could be due to the presence of Tween, as treatment with tween alone also reduces yellow rust development. However, comparison of the treatments with only Tween, and 10% zosteric acid with Tween, shows that addition of zosteric acid results in a reduction in disease development. The data also shows that zosteric acid is not as effective in preventing disease as currently used fungicides.

However, this is to be expected considering that no formulation development has been conducted for zosteric acid as a contact fungicide. Considering the lack of formulation, this data suggests that zosteric acid has a large potential as a contact fungicide to prevent disease in row crops.

### Example 4: Zosteric Acid as a Seed Dressing Fungicide to Treat Bunt of Wheat (Tilletia Caries) and Barley Stribe (Pyrenophora Graminea)

To investigate if zosteric acid can be applied as a seed dressing agent to prevent different seed borne fungal infections, the ability of zosteric acid to prevent infection of wheat and barley with the common bunt of wheat caused by tilletia caries and barley stribe, caused by pyronophora graminea was tested.

Treatment of either wheat or barley seeds with either 0.1% or 1% zosteric acid reduced the percentage of infected plant ears by more than 2-fold compared to the untreated control, providing significant protection against disease development. Development and application of a proper formulation is expected to increase the efficacy of zosteric acid further, making the efficacy comparable to that of current used standard fungicide treatments such as Redigo Pro. Interestingly, for protection against common bunt of wheat, a strong synergistic effect was seen when applying zosteric acid in combination with Redigo Pro, suggesting zosteric acid can be used in combination with other currently used fungicides to increase efficiency. These data clearly show that zosteric acid can be used as a seed dressing agent to effectively protect against a series of different fungal diseases in different row crops such as wheat and barley.

### Example 5: Application of Zosteric Acid for Post-Harvest Fruit and Vegetable Preservation

To investigate if zosteric acid and/or coumaric acid can protect fruit and vegetables against post-harvest infection with different fungi, zosteric and coumaric acids fungicidal effect was tested in capsicums and lemons infected with Alternaria alternata and Penicillium digitatum, respectively. The tests were performed by acquiring the relevant fruit and vegetables from the local supermarket. Both fruit and vegetables were bought as organic produce to ensure a minimum of pesticides had already been applied. Subsequently, the produce was sprayed with either zosteric acid, coumaric acid or a control solution consisting of 50% demineralized water and 50% ethanol, which was the solution used for dissolving zosteric and coumaric acid. Each application treatment was performed in triplicate on three separate pieces of produce. After treatment, the produce was allowed to dry in a sterile laminar flow cabinet followed by a second round of application and drying. The produce was then inoculated with the relevant fungal spores using a grafting stick. Application of the fungal spore solution was performed on the underside of the produce to ensure additional fungal spore solution did not get deposited on the produce. The inoculated produce was subsequently placed in non-sealed plastic bags to prevent contamination with other organisms and to prevent the produce from drying out due to air circulation in the incubator. The wrapped capsicums and lemons were placed at 10° C. and the fungal growth followed by measuring the diameter of the growth from the point of inoculation for 25 days.

For capsicums, two of the three replicates sprayed with the control solution had A. alternata growth after five days, whereas none of the replicates treated with zosteric or coumaric acid displayed any A. alternata growth until 19 and 25 days after inoculation respectively, suggesting both zosteric and coumaric acid can protect capsicums from post-harvest infection with A. alternata. For lemons, a single replicate from both the control and coumaric acid treatment had P. digitatum growing after four days whereas growth on lemons treated with zosteric acid was not observed until 19 days after inoculation. In addition, by the end of the test period (day 25) all replicates treated with control solution or coumaric acid had P. digitatum growth, whereas only a single replicate treated with zosteric acid displayed infection with P. digitatum. Combined, these results suggest that zosteric acid, but not coumaric acid, is able to protect lemons from post-harvest infection with P. digitatum. Due to practical limitations, the sample size in the performed experiment was relatively small and therefore statistical analysis of the results could not be reliably conducted. However, there are clear indications from this preliminary data that zosteric acid, and in some cases also coumaric acid, can protect different fruits and vegetables against a selection of different fungal infections.

### Example 6: Study of Fungicidal Effect of Zosteric Acid Against Downy Mildew in Wine

The present example evaluates the fungicidal effect of zosteric acid against downy mildew in grapes.

### Materials & Methods

The fungicidal effect of zosteric acid was tested against downy mildew in grapevine (plasmopara viticola), in standard European grapes (Vitis vinifera). The test was performed as standard controlled environment trial with four replicates for each treatment. Zosteric acid was applied as a formulation containing; zosteric acid (X % depending on the treatment), potassium carbonate (3%), Atlox AL2575 LF (wetting agent, 1%), Silcolapse Clear 30 (antifoam 0.01%) and water. The treatments were applied as a spray to the foliage of the crop using a cabin u-form sprayer operating at 3 BAR with a Lechler nozzle type of model 0.2 with four nozzles/rows. The sprayer was operating at a ground speed of 2.25 kilometers per hour and spraying 200 L/ha.

### Results

To quantify the fungicidal and phytotoxic effects of the zosteric acids treatments, the disease progression and phytotoxicity were visually evaluated and scored 17 and 13 days, respectively, after application of the treatment. For comparison, an untreated control and a standard fungicide treatment used for downy mildew (currently copper is the standard treatment) was also included in the study design. From the results there is a clear dose response in the zosteric acid treatments, with increasing doses resulting in increased disease control, suggesting that zosteric acid is the active ingredient in the treatments. In addition, the results show that 1% zosteric acid treatment can control the disease at levels similar to a standard fungicide treatment (0.5 grams of copper) (FIG. 1A). The phytotoxicity evaluation it shows that, at high concentrations (>2%), zosteric acid start to be phytotoxic. However, at 1% zosteric acid, which is the relevant concentration for disease control, zosteric acid shows very low phytotoxicity (<0.5%).

### Conclusions

The present example demonstrates that zosteric acid is highly effective against oomycetes and in particular against downy mildew in wine. This shows that zosteric acid can control disease at concentrations that show no phytotoxicity and that disease control is similar to what is observed with currently used standard treatment.

### Example 7: Study of Fungicidal Effect of Zosteric Acid Against Potato Blight in Potato

The present example evaluates the fungicidal effect of zosteric acid against potato blight in potato.

### Materials & Methods

To investigate if zosteric acid displayed fungicidal effects against late potato blight (Phytophtora infestans) in potatoes (Solanum tuberosum, variety Venezia) a climate chamber test was conducted. The application was conducted with a Research Track Sprayer and three different concentrations of zosteric acid (0.1%, 1%, and 5%) were sprayed one day before pathogen inoculation and two different concentrations of zosteric acid (1% and 5%) were sprayed after inoculation as soon as the infection got visible. Plants were assessed for phytotoxicity and pest severity 0, 4, and 7 days after the curative application.

### Results

As expected, development of late potato blight increased steadily over the assessment period for all treatments. However, treatment of potatoes with 5% zosteric acid and 0.3 L/ha BREAK THRU (wetting agent) reduced pest severity by 7.8%, 7.3% and 6.6% after 0, 4, and 7 days from the curative treatment, which was a significant reduction in pest severity compared to the untreated control. No phytotoxic effects were observed throughout the trials, suggesting that zosteric acid was able to control pest severity without adverse effects on plant health or growth.

### Conclusions

These results suggest that zosteric acid is an effective fungicide for control of late potato blight in potatoes. One thing to be noted is that, as opposed to the trials conducted against downy mildew in wine (example 1), the late potato blight trials were conducted with an unformulated product and formulation development is expected to increase efficacy substantially.

### Example 8: Study of Zosteric Acid as a Seed Dressing Fungicide to Treat Bunt of Wheat (Tilletia Caries) and Barley Stribe (Pyrenophora Graminea)

The present example evaluates the fungicidal effect of zosteric acid against bunt of wheat and Barley stribe.

### Materials & Methods

To investigate if zosteric acid can be applied as a seed dressing agent to prevent different seed borne fungal infections, the ability of zosteric acid to prevent infection of wheat and barley with the common bunt of wheat caused by tilletia caries and barley stribe, caused by pyronophora graminea) was tested.

### Results

Treatment of either wheat or barley seeds with either 0.1% or 1% zosteric acid reduced the percentage of infected plant ears by more than 2-fold compared to the untreated control, providing significant protection against disease development. Development and application of a proper formulation is expected to increase the efficacy of zosteric acid further, making the efficacy comparable to that of current used standard fungicide treatments such as Redigo Pro. Interestingly, for protection against common bunt of wheat, a strong synergistic effect was seen when applying zosteric acid in combination with Redigo Pro, suggesting zosteric acid can be used in combination with other currently used fungicides to increase efficiency. These data clearly show that zosteric acid can be used as a seed dressing agent to effectively protect against a series of different fungal diseases in different row crops such as wheat and barley.

### Conclusions

The present example demonstrates that zosteric acid is highly effective for treatment of bunt of wheat and Barley stribe.

### Examples 9: Sulfation of the Phenol Group of Hydroxycinnamic Acid and Derivatives Reduces Phytotoxicity without Compromising Efficacy

The present example evaluates the efficacy and phytotoxicity of zosteric acid compared to its non-sulfated version, coumaric acid.

### Materials & Methods

To investigate the biological effect of sulfation of hydroxycinnamic acids and derivatives, the fungicidal efficacy and phytoxicity of coumaric acid and zosteric acid (sulfated version of coumaric acid) was tested. The efficacy and phytotoxicity of coumaric- and zosteric-acid were tested against downy mildew in grapevine (plasmopara viticola), in standard European grapes (Vitis vinifera) as this has previously been identified as an appropriate trial system (see example one). The test was performed as standard controlled environment trial with four replicates for each treatment. Coumaric acid was applied as a formulation containing; coumaric acid (X % depending on the treatment), potassium carbonate (6%), Atlox AL2575 LF (wetting agent, 1.5%), Silcolapse Clear 30 (antifoam 0.01%) and water. Zosteric acid was applied as a formulation containing; zosteric acid (X % depending on the treatment), potassium carbonate (3%), Atlox AL2575 LF (wetting agent, 1%), Silcolapse Clear 30 (antifoam 0.01%) and water. The treatments were applied as a spray to the foliage of the crop using a cabin u-form sprayer operating at 3 BAR with a Lechler nozzle type of model 0.2 with four nozzles/rows. The sprayer was operating at a ground speed of 2.25 kilometers per hour and spraying 200 L/ha.

### Results

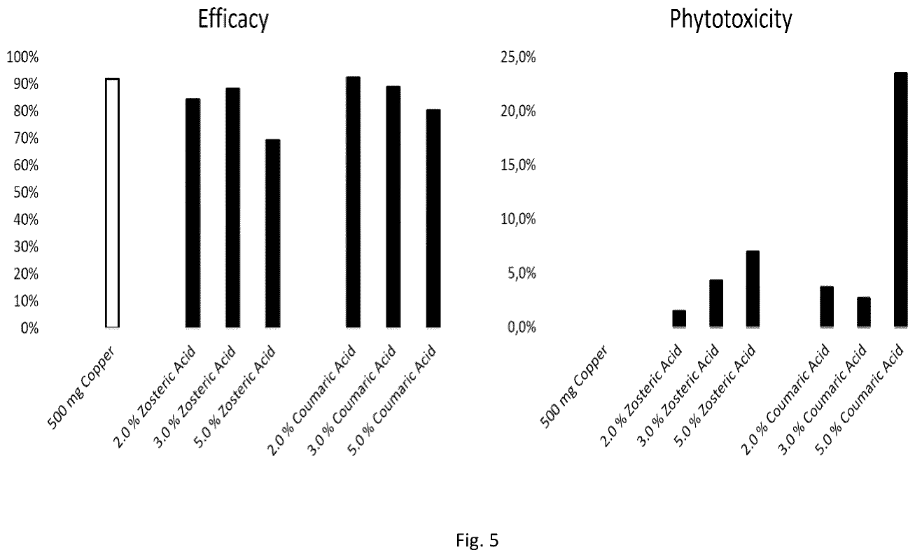

The results from the downy mildew trial are shown in FIG. 5. The results clearly show that coumaric- and zosteric-acid have similar efficacy at all concentrations tested, suggesting sulfation of the hydroxycinnamic acid does not affect its ability to control disease. As observed in the previous trial (see example one) zosteric and coumaric acid efficacy is comparable to the positive control Funguran Progress; a commercially used fungicide with copper as the active ingredient. While sulfation has no effect on efficacy, it strongly affects phytotoxicity. For example, 5% zosteric results in 7% phytotoxicity, compared to 23.5% for 5% coumaric acid treatment. These results clearly show that sulfation of hydroxycinnamic acids substantially reduces their phytotoxicity towards European grapes, and likely also other crops.

These results are also supported by previous literature. For example, Cattò C, Dell'Orto S, Villa F, Villa S, Gelain A, Vitali A, Marzano V, Baroni S, Forlani F, Cappitelli F. PLoS One. 2015 Jul. 1; 10(7) showed that zosteric and coumaric acid has similar abilities to prevent cell adhesion of E. coli cells, but only coumaric acid displayed biocidal activity (Cattò C, Dell'Orto S, Villa F, Villa S, Gelain A, Vitali A, Marzano V, Baroni S, Forlani F, Cappitelli F. PLoS One. 2015 Jul. 1; 10(7) and table 1)

### Conclusions

The present example demonstrates that sulfation of hydroxycinnamic acid and derivatives can reduce its phytotoxicity without reducing its fungicidal efficacy. Sulfation of hydroxycinnamic acid and derivatives therefore allows the development of compounds such as zosteric acid, that are efficacious with low phytotoxicity, which is key for development of improved agents for protection of crops.

### Example 10: Study of Biological Activity of Cis- Vs. Trans-Cinnamic Acid and Derivatives

The present example evaluates the anti-biofilm and biocidal efficacy of cis-hydroxycinnamic acid and derivatives against the respective trans-isomers.

### Materials & Methods

Catto et al. evaluated the anti-biofilm and biocidal activity of cis- and trans- zosteric-, coumaric- and cinnamic-acid against E. coli (Cattò C, Dell'Orto S, Villa F, Villa S, Gelain A, Vitali A, Marzano V, Baroni S, Forlani F, Cappitelli F. PLoS One. 2015 Jul. 1; 10(7)). The effects of the cinnamic compounds on E. coli cell adhesion were assessed quantitatively using fluorochrome-labeled cells in hydrophobic 96-well black sided plates as previously reported by Villa et al. (Villa F, Albanese D, Giussani B, Stewart P S, Daffonchio D, Cappitelli F. 2010 August; 26(6):739-52). The biocidal effect was investigated as described by Catto et al (Cattò C, Dell'Orto S, Villa F, Villa S, Gelain A, Vitali A, Marzano V, Baroni S, Forlani F, Cappitelli F. PLoS One. 2015 Jul. 1; 10(7)). Briefly, the planktonic growth of E. coli in LB medium supplemented with varying concentrations (0 μM, 0.183 μM, 1.83 μM, 18.3 μM, 183 μM, and 1830 μM) of the three compounds was followed by measuring OD600 nm every 10 minutes for 24 hours at 30° C.

### Results

At the concentrations tested by Catto et al. (Cattò C, Dell'Orto S, Villa F, Villa S, Gelain A, Vitali A, Marzano V, Baroni S, Forlani F, Cappitelli F. Unravelling the Structural and Molecular Basis Responsible for the Anti-Biofilm Activity of Zosteric Acid. PLoS One. 2015 Jul. 1; 10(7)), trans-zosteric acid showed no biocidal effect, but a good anti-biofilm efficacy at concentrations >1.83 μM (table 1). In contrast, cis-zosteric acid has no biocidal nor anti-biofilm activity, even at the higher concentrations tested, showing that only the trans version of zosteric acid exhibits biological activity at the concentrations tested. A similar trend is observed for coumaric acid, where trans-coumaric acid displays both biocidal and antibiofilm effect, whereas cis-coumaric acid has no biocidal activity and a strongly reduced anti-biofilm activity. Similarly, trans-cinnamic acid has significant anti-biofilm activity at concentrations >0.183 μM, whereas cis-cinnamic acid promotes biofilm formation at all concentrations tested. Combined these results clearly demonstrate that the trans-version of cinnamic acid and derivatives has greater biological activity, be it biocidal or anti-biofilm, as compared to their cis counterparts.

TABLE 1
Percentage reduction respect to the negative control is calculated as (ZA-related
compound data − control data) × 100 / control data.

| | | Planktonic growth | | Cell adhesion | |
|---|---|---|---|---|---|
| | Conc. | A₆₀₀/min (×10⁻³) | | N. adhered cells | |
| Cmpd | (μM) | Reduction (%) | | Reduction (×10⁷) (%) | |
| Trans | 0 | 1.28 ± 0.03^{a} | 0.00 | 1.92 ± 0.18^{b} | 0.00 |
| zosteric | 0.183 | 1.32 ± 0.06^{a} | 2.86 | 2.77 ± 0.17^{d} | 44.59 |
| acid | 1.83 | 1.31 ± 0.04^{a} | 1.76 | 1.54 ± 0.29^{c} | −19.76 |
| | 18.3 | 1.29 ± 0.04^{a} | 0.11 | 1.55 ± 0.19^{c} | −19.34 |
| | 183 | 1.30 ± 0.04^{a} | 1.07 | 1.39 ± 0.13^{c} | −27.67 |
| | 1830 | 1.30 ± 0.04^{a} | 1.21 | 0.56 ± 0.12^{a} | −70.56 |
| Cis | 0 | 1.28 ± 0.03^{a} | 0.00 | 1.92 ± 0.18^{bd} | 0.00 |
| zosteric | 0.183 | 1.31 ± 0.13^{a} | 2.28 | 3.79 ± 0.61^{c} | 98.02 |
| acid | 1.83 | 1.31 ± 0.01^{a} | 1.66 | 3.69 ± 0.41^{c} | 92.49 |
| | 18.3 | 1.31 ± 0.03^{a} | 2.24 | 3.54 ± 0.20^{c} | 84.50 |
| | 183 | 1.24 ± 0.03^{a} | −3.39 | 2.11 ± 0.14^{bd} | 9.90 |
| | 1830 | 1.22 ± 0.03^{a} | −4.98 | 4.30 ± 1.01^{c} | 124.16 |
| Trans- | 0 | 1.28 ± 0.03abc | 0.00 | 1.92 ± 0.18b | 0.00 |
| coumaric | 0.183 | 1.31 ± 0.03ab | 2.06 | 2.29 ± 0.16b | 19.37 |
| acid | 1.83 | 1.26 ± 0.04abc | −1.72 | 1.03 ± 0.14ce | −46.05 |
| | 18.3 | 1.23 ± 0.02abc | −3.99 | 1.42 ± 0.24de | −25.80 |
| | 183 | 1.23 ± 0.06abc | −3.87 | 1.49 ± 0.14de | −22.36 |
| | 1830 | 0.97 ± 0.04e | −24.17 | 1.22 ± 0.27cde | −36.38 |
| Cis- | 0 | 1.28 ± 0.03^{a} | 0.00 | 1.92 ± 0.18^{bc} | 0.00 |
| coumaric | 0.183 | 1.29 ± 0.07^{a} | 0.30 | 1.39 ± 0.15^{abc} | −27.34 |
| acid | 1.83 | 1.27 ± 0.05^{a} | −0.88 | 1.64 ± 0.11^{bc} | −14.39 |
| | 18.3 | 1.27 ± 0.04^{a} | −1.26 | 1.83 ± 0.14^{bc} | −4.30 |
| | 183 | 1.28 ± 0.06^{a} | −0.16 | 1.62 ± 0.19^{bc} | −15.26 |
| | 1830 | 1.25 ± 0.02^{a} | −2.25 | 5.45 ± 1.00^{e} | 184.36 |
| Trans- | 0 | 1.28 ± 0.03^{abc} | 0.00 | 1.92 ± 0.18^{bef} | 0.00 |
| cinnamic | 0.183 | 1.24 ± 0.04^{abcd} | −3.32 | 1.25 ± 0.43^{cdef} | −34.95 |
| acid | 1.83 | 1.22 ± 0.01^{abcdf} | −4.74 | 1.17 ± 0.17^{cdf} | −38.77 |
| | 18.3 | 1.19 ± 0.04^{bcdef} | −7.58 | 1.78 ± 0.10^{bcef} | −7.37 |
| | 183 | 1.14 ± 0.05^{def} | −11.37 | 1.44 ± 0.15^{bcdef} | −25.03 |
| | 1830 | 0.83 ± 0.02^{h} | −35.10 | 1.32 ± 0.28^{cdef} | −31.11 |
| Cis- | 0 | 1.28 ± 0.03^{ab} | 0.00 | 1.92 ± 0.18^{b} | 0.00 |
| cinnamic | 0.183 | 1.32 ± 0.04^{ab} | 2.71 | 2.46 ± 0.17^{b} | 28.52 |
| acid | 1.83 | 1.28 ± 0.07^{ab} | −0.56 | 2.36 ± 0.26^{b} | 23.00 |
| | 18.3 | 1.30 ± 0.03^{ab} | 1.27 | 1.35 ± 0.28^{b} | −29.61 |
| | 183 | 1.24 ± 0.05^{a} | −3.17 | 5.08 ± 0.53^{c} | 164.82 |
| | 1830 | 0.88 ± 0.02^{c} | −31.64 | 5.43 ± 0.76^{c} | 183.29 |

### Conclusions

The present example demonstrates that the trans-isomers of cinnamic acid and derivatives are more efficacious than the corresponding cis-isomers. Hence, provision of compositions comprising very high amounts of the trans-isomer lowers the composition mass required to provide the desired effect.

### Example 11: Evaluation of Efficacy of Hydroxycinnamic Acid and Derivatives Against Various Genus/Species

The present example evaluates the efficacy of hydroxycinnamic acid and derivatives against various genus and species to demonstrate that not all genus/species can efficiently be treated by the compounds of the present disclosure.

In total the efficacy of zosteric acid has been tested against 16 different fungi or oomycetes pests relevant within the agricultural sector in 9 different crops (table 2). 11 of the examples are presented in the current patent with the remaining five present in previous literature (Stanley M S, Callow M E, Perry R, Alberte R S, Smith R, Callow J A. Phytopathology. 2002 April; 92(4):378-83 and Villa F, Albanese D, Giussani B, Stewart P S, Daffonchio D, Cappitelli F. 2010 August; 26(6):739-52). The five examples presented in previous literature are limited to fungi from the division Ascomycota and class Sordariomycetes and Eurotiomycetes. However, the data summarized in table 2 show that zosteric acid is not effective against all fungi within the Ascomycota division. For example, zosteric acid was not effective in controlling powdery mildew in wheat caused by a fungi, Blumeria graminis f. sp. Tritici, that belongs to the Leotiomycetes class within the Ascomycota division. Similarly, zosteric acid was not effective in controlling septoria leaf blotch, blackleg disease, nor Cercospora leaf spot disease caused by Septoria tritici, Leptosphaeria maculans, and Cercospora beticola respectively, all of which belong to the Dothideomycetes class within the Ascomycota division. These results suggest that the efficacy of zosteric acid varies between the different classes of fungi within the same division, and it is by no means all fungi which zosteric acid is effective at controlling.

In addition to efficacy against fungi within the Ascomycota division, data presented herein also show that zosteric acid is effective against some fungi from the Basidiomycota division, such as Tilletia caries and Puccinia striiformis f.sp. tritici which cause common bunt of wheat and yellow rust in wheat, respectively. The variation in efficacy between different classes is also observed within the Basidiomycota division. For example, in the same trial setup, zosteric acid showed good efficacy against Tilletia caries, but no efficacy against Ustilago nuda, both of which belong to the Basidiomycota division but to the Exobasidiomycetes and Ustilaginomycetes classes respectively. These results show that the efficacy variation between different classes is independent of which division of fungi is tested and is likely a common characteristic of zosteric acid.

Besides being effective against fungi, zosteric acid was also found to be highly effective in controlling disease caused by different Oomycetes such as potato blight and downy mildew in wine caused by Phytophthora infestans and Plasmopara viticola respectively. Oomycetes are a class of filamentous, eukaryotic microorganisms that include some of the most devastating plant and animal pathogens. Oomycetes are members of the Kingdom Chromista (www.gbif.org and www.apsnet.org) and stramenopiles lineage of the stramenopiles-alveolata-rhizaria eukaryotic supergroup, with close relationships to the diatoms and brown algae. In contrast, fungi belong to the Kingdom Fungi or Eumycota (www.gbif.org). Adaptations of both Oomycetes and Fungi to obtaining their nutrients by absorption have resulted in considerable morphological convergence. As a result, Oomycetes resemble true fungi in terms of their morphology, filamentous growth, ecological niches, and modes of nutrition. Despite their extensive similarities, however, the evolutionary relationship between oomycetes and fungi represents one of the most distantly related evolutionary groupings within the eukaryotes. Considering the large evolutionary distance, it is highly surprising that zosteric acid works as well, if not better against oomycetes as it does against fungi.

TABLE 2
Overview of zosteric acid effect on different diseases, crops, and pests.

| | | | | | | zosteric | |
|---|---|---|---|---|---|---|---|
| | | | | | | acid | |
| | | | | | Fungi class, | effective | Origin of |
| Disease | Crop | Pest | Kingdom | Phylum/Division | Oomycetes order | (Yes/No) | data |
| Downy | Vitis | Plasmopara | Chromista | Oomycota | Peronosporales | Yes | This |
| mildew in | vinifera / | viticola | | | | | disclosure |
| wine | European | | | | | | |
| | grape | | | | | | |
| Powdery | Wheat | Blumeria | Fungi | Ascomycota | Leotiomycetes | No | This |
| mildew in | | graminis f. sp. | | | | | disclosure |
| wheat | | tritici | | | | | |
| Yellow rust | Wheat | Puccinia | Fungi | Basidiomycota | Urediniomycetes | Yes | This |
| in wheat | | striiformis f. sp. | | | | | disclosure |
| | | tritici | | | | | |
| Loose smut | Barley | Ustilago nuda | Fungi | Basidiomycota | Ustilaginomycetes | No | This |
| of barley | | | | | | | disclosure |
| Common | Wheat | Tilletia | Fungi | Basidiomycota | Exobasidiomycetes | Yes | This |
| bunt of | | caries | | | | | disclosure |
| wheat | | | | | | | |
| Barley | Barley | Pyrenophora | Fungi | Ascomycota | Ascomycetes | Yes | This |
| stripe | | graminea | | | | | disclosure |
| septoria | Beta | Septoria | Fungi | Ascomycota | Dothideomycetes | No | This |
| leaf blotch | vulgaris | tritici | | | | | disclosure |
| | vulg. | | | | | | |
| | altissima / | | | | | | |
| | sugarbeet | | | | | | |
| blackleg | Brassica | Leptosphaeria | Fungi | Ascomycota | Dothideomycetes | No | This |
| disease | napus / | maculans | | | | | disclosure |
| | winter rape | | | | | | |
| Cercospora | Beta | Cercospora | Fungi | Ascomycota | Dothideomycetes | No | This |
| leaf spot | vulgaris | beticola | | | | | disclosure |
| disease | vulg. | | | | | | |
| | altissima / | | | | | | |
| | sugarbeet | | | | | | |
| Potato | Solanum | Phytophthora | Chromista | Oomycota | Peronosporales | Yes | This |
| blight | tuberosum / | infestans | | | | | disclosure |
| | potato | | | | | | |
| Powdery | Strawberries | Podosphaera | Fungi | Ascomycota | Leotiomycetes | Yes | This |
| mildew in | | aphanis | | | | | disclosure |
| strawberries | | | | | | | |
| Rice blast | Rice | Magnaporthe | Fungi | Ascomycota | Sordariomycetes | Yes | Stanley |
| | | grisea | | | | | 2002 |
| Bean | Bean | Colletotrichum | Fungi | Ascomycota | Sordariomycetes | Yes | Stanley |
| anthracnose | | lindemuthianum | | | | | 2002 |
| Anthracnose | Strawberries | Colletotrichum | Fungi | Ascomycota | Sordariomycetes | | * |
| of | | fragariae | | | | | |
| strawberry | | | | | | | |
| Mold on | N/A (In | Penicillium | Fungi | Ascomycota | Eurotiomycetes | Yes | Villa et al |
| citrus fruits | vitro) | citrinum | | | | | 2010 |
| Common | N/A (In | Aspergillus | Fungi | Ascomycota | Eurotiomycetes | Yes | Villa et al |
| mold | vitro) | niger | | | | | 2010 |

Stanley 2002 refers to “Stanley M S, Callow M E, Perry R, Alberte R S, Smith R, Callow J A. Phytopathology. 2002 Apr.; 92(4): 378-83”;
* refers to “2000 Southern Division Meeting Abstracts, Mar. 5-7, 2000 - Gainesville, Florida, Posted online March 23, 2000”;
Villa et al 2010 refers to “Villa F, Albanese D, Giussani B, Stewart P S, Daffonchio D, Cappitelli F. 2010 Aug.; 26(6): 739-52”.

### Conclusions

The examples above clearly demonstrate that predicting which target organism zosteric acid is effective against is not straight forward. Zosteric acid was effective against all Oomycetes tested

### Example 12: Study of Fungicidal Effect of Zosteric Acid Against Powdery Mildew in Strawberries

The present example evaluates the fungicidal effect of zosteric acid against powdery mildew in strawberries.

### Materials & Methods

The fungicidal effect of zosteric acid was tested against powdery mildew (Podosphaera aphanis) in strawberries (Fragaria sp.). The test was performed as standard controlled environment trial. Zosteric acid was applied as a formulation containing; zosteric acid (X % depending on the treatment), potassium carbonate (3%), Bond (wetting agent and spreader, 0.5 l/ha), and water. Five different treatments were applied; 1) an untreated control, 2) zosteric acid at 3%, 3) zosteric acid at 6%, 4) zosteric acid at 9%, 5) Karma at 3 kg/ha. The treatments were applied as a spray to the foliage of the crop. Four treatment applications were performed at day 0, 7, 14, and 21 respectively. Prior to each application the infection and phytotoxicity of the plants were evaluated and scored.

### Results

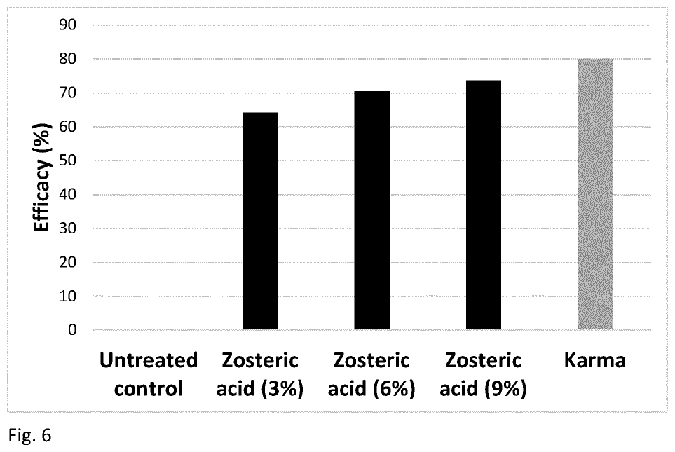

To quantify the fungicidal and phytotoxic effects of the treatments the disease progression and phytotoxicity were visually evaluated and scored 0, 7, 14, 21, and 30 days, after application of the first treatment. For comparison, an untreated control and a standard fungicide treatment used for powdery mildew (Karma) was also included in the study design. The results demonstrate that zosteric acid is efficient at controlling disease development at all the concentrations tested (FIG. 6). Furthermore, there is not statistical difference between the efficacy of Karma and the zosteric acid treatments, suggested zosteric acid can control disease progression at levels similar to currently used products on the market.

### Conclusions

The present example demonstrates that zosteric acid is highly effective against powdery mildew in strawberries. This shows that zosteric acid can control disease at concentrations that show no phytotoxicity and that disease control is similar to what is observed with currently used standard treatment.

1. A method for inhibiting proliferation of a phytopathogen on a plant or a product derived therefrom, comprising contacting the phytopathogen with a composition comprising a hydroxycinnamic acid or a derivative thereof thereby inhibiting proliferation of the phytopathogen.

2. A method for protection of a plant or a product derived therefrom against at least one phytopathogen, comprising applying a composition comprising a hydroxycinnamic acid or a derivative thereof to the surface of said plant or a product derived therefrom.

3. The method according to any one of the preceding claims, wherein the composition comprises an amount of hydroxycinnamic acid or a derivative thereof effective to inhibit proliferation of the phytopathogen.

4. The method according to anyone of the preceding claims, wherein the composition is applied to the surface of said plant or a product derived therefrom, such as crops, seeds, or fruits, by spraying or by immersion the plant or a product derived therefrom into said composition.

5. The method according to any of the preceding claims, wherein the composition is applied by spraying.

6. The method according to any one of the preceding claims, wherein the composition is applied to fruits post-harvest.

7. The method according to any one of the preceding claims, wherein the composition is applied as a liquid composition comprising the hydroxycinnamic acid or a derivative thereof in a concentration from about 0.1% w/w to about 10% w/w, water and optionally a preservative.

8. The method according to any one of the preceding claims, wherein the at least one phytopathogen is an oomycete or a fungus.

9. The method according to any one of the preceding claims, wherein the at least one phytopathogen is an oomycete.

10. The method according to any one of the preceding claims, wherein the at least one phytopathogen is an oomycete of an order selected from the group consisting of: peronosporales, pythiales, albuginales, and saprolegniales.

11. The method according to any one of the preceding claims, wherein the at least one phytopathogen is an oomycete selected from the group consisting of: Achlya spp., Aphanomyces spp., Bremia lactucae, Halophytophthora spp., Lagenidium spp., Olpidiopsis spp., Phytopythium spp., Plasmoverna spp., Pseudoperonospora spp., Saprolegnia spp., Synchytrium spp., and Trogoderma spp.

12. The method according to any one of the preceding claims, wherein the at least one phytopathogen is an oomycete selected from the group consisting of: Peronospora spp., such as Peronospora destructor or Peronospora tabacina; and Plasmopara spp., such as Plasmopara viticola.

13. The method according to any one of the preceding claims, wherein the method protects against a disease selected from the group consisting of downy mildew, such as downy mildew caused by Peronospora spp.; powdery mildew, such as powdery mildew caused by Podosphaera aphanis; late blight, such as late blight caused by Phytophthora infestans; Asian soy rust, such as Asian soy rust caused by Phakopsora pachyrhizi, Pythium root rot, such as Pythium root rot caused by Pythium spp.; damping-off; white rust diseases, such as white rust diseases caused by oomycetes of the order Albuginales; Sclerophthora macrospora blight, and Plasmopara viticola causing downy mildew in grapevines.

14. The method according to any one of the preceding claims, wherein the method protects against downy mildew caused by Plasmopara viticola.

15. The method according to any one of claims 1-8, wherein the at least one phytopathogen is a fungus.

16. The method according to claim 15, wherein the fungus is an ascomycetous fungus.

17. The method according to claim 15, wherein the ascomycetous fungus is Podosphaera aphanis.

18. The method according to any one of the preceding claims, wherein the method protects against bunt of wheat and/or Barley stripe.

19. The method according to any one of the preceding claims, wherein the crops are selected from the group consisting of: grapes, such as grape vines, potatoes, tomatoes, lettuce, onions, tobacco, cucurbits, cruciferous vegetables, spinach, corn, pulses, and soybeans.

20. The method according to any one of the preceding claims, wherein the crops are wine grapes.

21. The method according to any one of the preceding claims, wherein the crops are corn or soybeans.

22. The method according to any one of the preceding claims, wherein the seeds are selected from the group consisting of: wheat, oat, rye, corn, rice, cucumber seeds, corn, soybean, melon seeds, squash seeds, and pumpkin seeds.

23. The method according to any one of the preceding claims, wherein the fruits are selected from the group consisting of: grapes, such as grape clusters and fruits of grape, strawberries, raspberries, and blueberries.

24. The method according to any one of the preceding claims, wherein the method protects against downy mildew caused by Plasmopara viticola in grapes, such as grapevines.

25. The method according to any one of the preceding claims, wherein the method protects against powdery mildew in strawberries, for example strawberries of the Fragaria species.

26. The method according to any one of claims 1-7, wherein said crops are grape vines (Vitis vinifera) and the method protects against downy mildew (Plasmopara viticola).

27. The method according to any of claims 1-7, wherein said crops is potato and the method protects against late blight of potato (Phytophthora infestans).

28. The method according to claims 1-7, wherein the method protects against Tilletia caries and the crops or seeds are wheat (Triticum aestivum).

29. The method according to any of claims 1-7, wherein the method protects against Pyrenophora graminea and the crops are Barley (Hordeum vulgare).

30. The method according to any of the preceding claims, wherein said hydroxycinnamic acid or a derivative thereof is 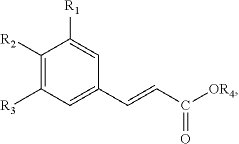
or a salt thereof,
wherein R₁, R₂ and R₃ independently are selected from the group consisting of hydrogen (H), hydroxyl (OH), C₁₋₆-alkyl and C₁₋₆-alkoxy, —O—SO₂—OR₅, wherein R₅ is selected from the group consisting of: hydrogen and C₁₋₆-alkyl;
provided that at least one of R₁, R₂ and R₃ is hydroxyl (OH) or —O—SO₂—OR₅, and R₄ is selected from the group consisting of hydrogen (H) and C₁₋₆-alkyl.

31. The method according to claim 30, wherein R₂ is —O—SO₂—OR₅.

32. The method according to any one of claims 30-31, wherein R₂ is —O—SO₂—OR₅ and R₅ is hydrogen.

33. The method according to any one of claims 30-32, wherein the hydroxycinnamic acid or derivative thereof is zosteric acid.

34. The method according to any one of claims 30-33, wherein the hydroxycinnamic acid or a derivative thereof is a salt.

35. The method according to any one of claims 30-34, wherein the hydroxycinnamic acid or a derivative thereof is a alkali metal salt, for example a sodium or a potassium salt, optionally a monosodium or monopotassium salt.

36. The method according to claim 35, wherein the hydroxycinnamic acid or a derivative thereof is a monosodium or monopotassium salt of zosteric acid.

37. The method according to any one of the preceding claims, wherein the composition comprises the hydroxycinnamic acid or derivative thereof in a concentration from about 0.1% w/w to about 10% w/w, water, and optionally a preservative.

38. The method according to any one of claims 1-8, wherein:
a. the hydroxycinnamic acid or derivative thereof is zosteric acid,
b. the concentration of zosteric acid is from 0.5% to 3.0% w/w, for example 1% w/w;
c. the plant or product derived therefrom is grapes; and
d. the phytopathogen is plasmopara viticola, optionally present with symptoms of downy mildew.

39. The method according to any one of claims 1-8, wherein:
a. the hydroxycinnamic acid or derivative thereof is zosteric acid,
b. the concentration of zosteric acid is from 0.1% to 6% w/w, for example from 3 to 6%, such as from 4 to 5% w/w, such as 5% w/w;
c. the plant or product derived therefrom is potato; and
d. the phytopathogen is Solanum tuberosum, variety Venezia, optionally present with symptoms of potato blight.

40. The method according to any one of claims 1-8, wherein:
a. the hydroxycinnamic acid or derivative thereof is zosteric acid,
b. the concentration of zosteric acid is from 0.1% to 3% w/w, for example from 0.5% to 2%, such as from 0.8% to 1.5% w/w, such as 1% w/w;
c. the plant or product derived therefrom is wheat or barley; and
d. the phytopathogen is Tilletia caries, optionally present with symptoms of bunt of wheat, or Pyrenophora graminea, optionally present with symptoms of Barley stibe.

41. The method according to any one of claims 1-8, wherein:
a. the hydroxycinnamic acid or derivative thereof is zosteric acid,
b. the concentration of zosteric acid is from 0.1% to 3% w/w, for example from 0.5% to 2%, such as from 0.8% to 1.5% w/w, such as 1% w/w;
c. the plant or product derived therefrom is a strawberry; and
d. the phytopathogen is Podosphaera aphanis, optionally present with symptoms of powdery mildew.

42. The method according to any one of the preceding claims, wherein the composition comprises the hydroxycinnamic acid or derivative thereof with a trans/cis-ratio of at least 90:10, such as at least 91:9, such as at least 92:8, such as at least 93:7, such as at least 94:6, such as at least 95:5, such as at least 96:4, such as at least 97:3, such as at least 98:2, such as at least 99:1, for example 100:0.

43. The method according to any one of the preceding claims, wherein the composition is a biobased composition.

44. The method according to any one of the preceding claims, wherein the composition comprises at least 20% biobased carbon, such as at least 30% biobased carbon, such as at least 40% biobased carbon, such as at least 50% biobased carbon, such as at least 60% biobased carbon, such as at least 70% biobased carbon, such as at least 75% biobased carbon, such as at least 80% biobased carbon, such as at least 85% biobased carbon, such as at least 90% biobased carbon, such as at least 95% biobased carbon, such as 100% biobased carbon.

45. The method according to any one of the preceding claims, wherein the composition comprises from 20% to 100% biobased carbon, such as from 30% to 100% biobased carbon, such as from 40% to 100% biobased carbon, such as from 50% to 100% biobased carbon, such as from 60% to 100% biobased carbon, such as from 70% to 100% biobased carbon, such as from 75% to 100% biobased carbon, such as from 80% to 100% biobased carbon, such as from 85% to 100% biobased carbon, such as from 90% to 100% biobased carbon, such as from 95% to 100% biobased carbon, such as 100% biobased carbon.

46. A composition comprising a hydroxycinnamic acid or derivative thereof according to the formula: 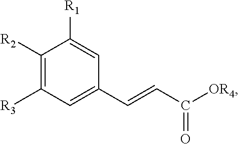
or a salt thereof,
wherein R₁, R₂ and R₃ independently are selected from the group consisting of hydrogen (H), hydroxyl (OH), C₁₋₆-alkyl and C₁₋₆-alkoxy, —O—SO₂—OR₅, wherein R₅ is selected from the group consisting of: hydrogen and C₁₋₆-alkyl;
provided that at least one of R₁, R₂ and R₃ is hydroxyl (OH) or —O—SO₂—OR₅, and R₄ is selected from the group consisting of hydrogen (H) and C₁₋₆-alkyl.

47. The composition according to claim 46, wherein R₂ is —O—SO₂—OR₅.

48. The composition according to any one of claims 46-47, wherein R₂ is —O—SO₂—OR₅ and R₅ is hydrogen.

49. The composition according to any one of claims 46-48, wherein the hydroxycinnamic acid or derivative thereof is zosteric acid.

50. The composition according to any one of claim 46, wherein the composition is a biofungicide.

51. The composition according to any one of claims 46-50, wherein the composition comprises the hydroxycinnamic acid or derivative thereof in a concentration from about 0.1% w/w to about 10% w/w, water and optionally a preservative.

52. The composition according to any one of claims 46-51, wherein the composition comprises the hydroxycinnamic acid or derivative thereof with a trans/cis-ratio of at least 90:10, such as at least 91:9, such as at least 92:8, such as at least 93:7, such as at least 94:6, such as at least 95:5, such as at least 96:4, such as at least 97:3, such as at least 98:2, such as at least 99:1, for example 100:0.

53. The composition according to any one of claims 46-52, wherein the composition is a biobased composition.

54. The composition according to any one of claims 46-53, wherein the composition comprises at least 20% biobased carbon, such as at least 30% biobased carbon, such as at least 40% biobased carbon, such as at least 50% biobased carbon, such as at least 60% biobased carbon, such as at least 70% biobased carbon, such as at least 75% biobased carbon, such as at least 80% biobased carbon, such as at least 85% biobased carbon, such as at least 90% biobased carbon, such as at least 95% biobased carbon, such as 100% biobased carbon.

55. The composition according to any one of claims 46-54, wherein the composition comprises from 20% to 100% biobased carbon, such as from 30% to 100% biobased carbon, such as from 40% to 100% biobased carbon, such as from 50% to 100% biobased carbon, such as from 60% to 100% biobased carbon, such as from 70% to 100% biobased carbon, such as from 75% to 100% biobased carbon, such as from 80% to 100% biobased carbon, such as from 85% to 100% biobased carbon, such as from 90% to 100% biobased carbon, such as from 95% to 100% biobased carbon, such as 100% biobased carbon.

56. A crop comprising the composition as defined in any one of claims 46-55.

57. A fruit comprising the composition as defined in any one of claims 46-55.

58. A seed comprising the composition as defined in any one of claims 46-55.
